(19) United States
(12) Patent Application Publication
(10) Pub. No.: US 2024/0394685 A1
(43) Pub. Date: Nov. 28, 2024

(54) TERMINAL APPARATUS, INFORMATION PROCESSING APPARATUS, INFORMATION PROCESSING SYSTEM, AND INFORMATION PROCESSING METHOD

(71) Applicant: Sony Group Corporation, Tokyo (JP)

(72) Inventors: Kenta Endo, Kanagawa (JP); Mikio Ishimaru, Tokyo (JP); Takao Tanikame, Kanagawa (JP); Sho Nishida, Kanagawa (JP); Nicholas Walker, London (GB); Matthew Lawrenson, Lausanne (CH); Harm Cronie, Echallens (NL)

(21) Appl. No.: 18/261,617

(22) PCT Filed: Jan. 14, 2022
(86) PCT No.: PCT/JP2022/001160

§ 371 Date: Jul. 14, 2023

(30) Foreign Application Priority Data
Jan. 22, 2021 (JP) 2021-008996

(51) Int. Cl. G06Q 20/32; G01S 7/481; G01S 17/08; G01S 17/86; G06K 7/14; G06Q 20/20; H04L 9/40

(52) U.S. Cl. CPC G06Q 20/3276; G01S 7/4814; G01S 17/08; G01S 17/86; G06K 7/1417; G06Q 20/204; H04L 63/0428

(57) ABSTRACT

A terminal apparatus (20) according to an embodiment includes: a first ranging unit (203) including a light source unit (2110) and a light reception unit (2111) and configured to perform range-finding on a basis of light emitted from the light source unit and light received by the light reception unit, and a control unit (219) configured to control the first ranging unit, in which the control unit controls light emission from the light source unit included in the first ranging unit in response to transmission data to transmit the transmission data to another equipment using light and to cause the first ranging unit to execute the range-finding at least once before completing transmission of the transmission data.

### FIELD

The present disclosure relates to a terminal apparatus, an information processing apparatus, an information processing system, and an information processing method.

### BACKGROUND

In recent years, the electronic payment that makes a payment for products or the like using a code image of a two-dimensional code, such as a quick response (QR) code (registered trademark), has become widespread.

Payment processing in such an electronic payment using the QR code has been implemented employing, for example, a method of making a payment by reading a fixed (e.g., printed) QR code that includes merchant information with a mobile terminal of a user who is a purchaser, a method of making a payment by a merchant reading a QR code that is dynamically generated and displayed on a user's mobile terminal, or the like.

### CITATION LIST

### Non Patent Literature

Non Patent Literature 1: “Commentary on Two Major Electronic Payment Platforms in China and Features of Alipay and WeChat Pay”, by the editorial department of Honichi (Visit Japan Lab), [online], Oct. 21, 2020, [searched on Dec. 2, 2020], Internet <URL: https://honichi.com/news/2020/08/06/scancodepaymentsinchina/>

### SUMMARY

### Technical Problem

The existing electronic payments using QR codes require a connection to a payment server via the Internet for user authentication, receipt of payment completion notification, or the like. The challenging connection to the Internet of a mobile terminal used by a user can cause the electronic payment concerned to fail to be executed. Such existing electronic payments using QR codes can be difficult to be executed, for example, in cases where the communication environment over the Internet is not properly equipped, travelers make a payment overseas or the like.

The present disclosure is intended to provide a terminal apparatus, information processing apparatus, information processing system, and information processing method, enabling electronic payments using a code image even with a challenging connection to the Internet by a purchaser's terminal.

### Solution to Problem

For solving the problem described above, a terminal apparatus according to one aspect of the present disclosure has a first ranging unit including a light source unit and a light reception unit and configured to perform range-finding on a basis of light emitted from the light source unit and light received by the light reception unit; and a control unit configured to control the first ranging unit, wherein the control unit controls light emission from the light source unit included in the first ranging unit in response to transmission data to transmit the transmission data to another equipment using light and to cause the first ranging unit to execute the range-finding at least once before completing transmission of the transmission data.

For solving the problem described above, an information processing apparatus according to one aspect of the present disclosure has a generation unit configured to generate a first code that is based on an image on a basis of input information to cause the first code to be displayed on a display unit; and a receiver configured to receive transmission data transmitted using light from another equipment, wherein the generation unit generates a second code that is based on an image on a basis of the transmission data received by the receiver and causes the generated second code to be displayed on the display unit.

For solving the problem described above, an information processing system according to one aspect of the present disclosure has a terminal apparatus; and an information processing apparatus, wherein the terminal apparatus includes a ranging unit including a light source unit and a light reception unit and configured to perform range-finding on a basis of light emitted from the light source unit and light received by the light reception unit, a readout unit configured to read out a code that is based on image information, and a control unit configured to control light emission by the light source unit included in the ranging unit in response to transmission data to transmit the transmission data using light to the information processing apparatus and to cause the ranging unit to execute the range-finding at least once before completing transmission of the transmission data, wherein the information processing apparatus includes a receiver configured to receive the transmission data transmitted using light from the terminal apparatus, and a generation unit configured to generate a first code that is based on an image on a basis of input information, causing the first code to be displayed on a display unit and configured to generate a second code that is based on an image on a basis of the transmission data received by the receiver, causing the second code to be displayed on the display unit, wherein the control unit causes the readout unit to read out the first code, causes the transmission data to be generated on a basis of information included in the read-out first code, and causes the generated transmission data to be transmitted using light to the information processing apparatus.

An information processing method according to one aspect of the present disclosure comprises, executed by a processor, a ranging step of performing range-finding on a basis of light emitted from a light source unit and light received by a light reception unit; and a control step of controlling the ranging step, wherein, in the control step, light emission by the light source unit is controlled in response to transmission data to transmit the transmission data to another equipment, causing the range-finding to be executed in the ranging step at least once before completing transmission of the transmission data.

### BRIEF DESCRIPTION OF DRAWINGS

FIG. 1 is a schematic diagram roughly illustrating an information processing system commonly applied to embodiments.

FIG. 2 is a diagram illustrating an exemplary configuration of the information processing system applicable to embodiments.

FIG. 3 is a block diagram illustrating an exemplary hardware configuration of a POS register applicable to embodiments.

FIG. 4 is a block diagram illustrating an exemplary hardware configuration of a mobile terminal applicable to embodiments.

FIG. 5 is a diagram schematically illustrating the external appearance of an exemplary mobile terminal applicable to embodiments.

FIG. 6 is a block diagram illustrating an exemplary configuration of a ranging unit applicable to embodiments.

FIG. 7 is a diagram illustrated to describe the principle of the indirect time of flight (ToF) technique.

FIG. 8 is a schematic diagram illustrated to specifically describe an approach to calculating a piece of distance information in the indirect ToF technique.

FIG. 9 is an exemplary functional block diagram illustrated to describe the functions of a POS register according to a first embodiment.

FIG. 10 is an exemplary functional block diagram illustrated to describe the functions of a mobile terminal according to the first embodiment.

FIG. 11 is an exemplary flowchart illustrating payment processing according to the first embodiment.

FIG. 12 is a schematic diagram illustrating an example of a two-dimensional code image displayed on a display of the POS register applicable to the first embodiment.

FIG. 13 is a schematic diagram illustrating an example of a transaction information screen displayed on a touch panel of the mobile terminal applicable to the first 25 embodiment.

FIG. 14 is a schematic diagram illustrated to describe the determination of comparison between a threshold and distances D_{USER} and D_{POS} according to the first embodiment.

FIG. 15 is a schematic diagram illustrating an example of a screen for transmission indicating the transmission status of payment information displayed on the touch panel of the mobile terminal applicable to the first embodiment.

FIG. 16 is a schematic diagram illustrating an example of a payment result screen illustrating the result of payment displayed on the touch panel of the mobile terminal applicable to the first embodiment.

FIG. 17 is a schematic diagram illustrating an example of varying the number of light reception elements to be driven in the rear-side ranging unit according to a second modification of the first embodiment.

FIG. 18 is a schematic diagram illustrated to describe a light irradiation area by a rear-side ranging unit according to a third modification of the first embodiment.

FIG. 19 is a schematic diagram illustrating an exemplary configuration of an information processing system according to a sixth modification of the first embodiment.

FIG. 20 is a schematic diagram illustrating an exemplary configuration of an information processing system according to a seventh modification of the first embodiment.

FIG. 21 is an exemplary functional block diagram illustrated to describe the functions of a POS register according to a second embodiment.

FIG. 22 is an exemplary functional block diagram illustrated to describe the functions of a mobile terminal according to the second embodiment.

FIG. 23 is an exemplary flowchart illustrating payment processing according to the second embodiment.

### DESCRIPTION OF EMBODIMENTS

The description is now given of embodiments of the present disclosure in detail with reference to the drawings. Moreover, in embodiments described below, the same components are denoted by the same reference numerals, and so a description thereof is omitted.

Embodiments of the present disclosure are now described in the following order.
1. Overview Description of Present Disclosure
2. Technologies applicable to Embodiments
2-1. Configuration applicable to Embodiments
2-2. Range-finding Methods applicable to Embodiments
3. First Embodiment of Present Disclosure
3-0-1. Configuration according to First Embodiment
3-0-2. Details of processing according to First Embodiment
3-1. First Modification of First Embodiment
3-2. Second Modification of First Embodiment
3-3. Third Modification of First Embodiment
3-4. Fourth Modification of First Embodiment
3-5. Fifth Modification of First Embodiment
3-6. Sixth Modification of First Embodiment
3-7. Seventh Modification of First Embodiment
4. Second Embodiment of Present Disclosure
4-0-1. Configuration according to Second Embodiment
4-0-2. Details of Processing according to Second Embodiment

### 1. Overview Description of Present Disclosure

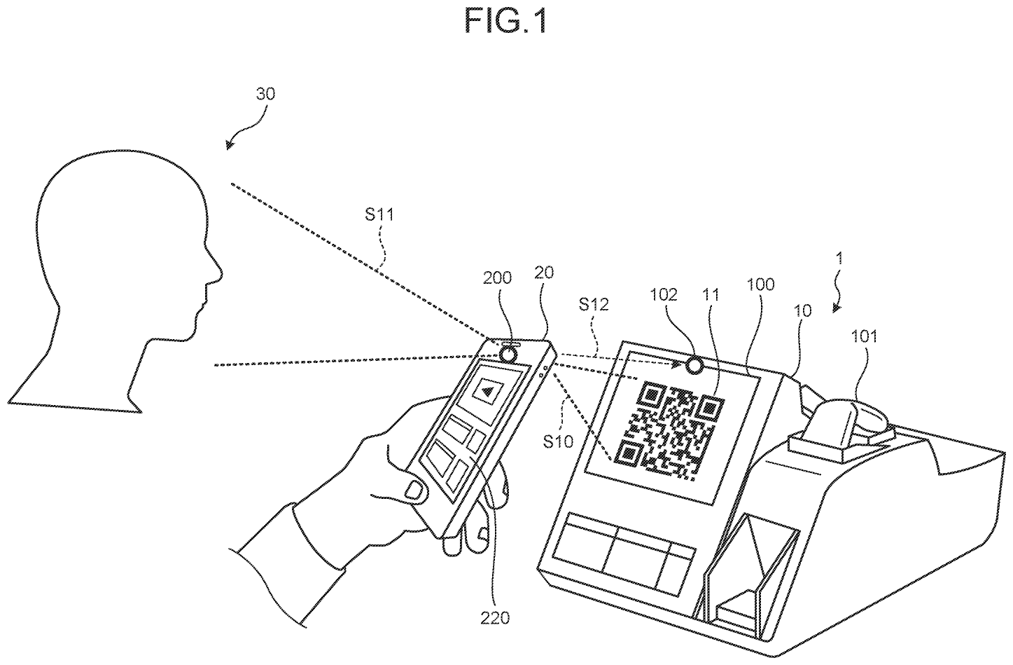

An information processing system commonly applied to embodiments of the present disclosure is now schematically described. FIG. 1 is a schematic diagram roughly illustrating the information processing system commonly applied to embodiments. In FIG. 1, the information processing system includes a POS register 10 and a mobile terminal 20 such as a smartphone.

The POS register 10 is terminal equipment connected to a point-of-sale (POS) system (not illustrated) and used to make a payment for purchases by a user 30. The POS register 10 roughly includes a display 100 and an input device 101 through which information such as the price of a product or item purchased by the user 30 is entered. The input device 101 is, for example, a barcode scanner, which performs optical scanning of a barcode on a product to acquire information used to identify the product. The input device 101 is not limited to barcode scanners and can be, for example, a keyboard for manually entering an amount of money.

The POS register 10 according to embodiments also includes a light reception unit 102 that receives light and outputs a signal corresponding to the received light.

Portable information terminals such as smartphones or tablet personal computers can be employed as the mobile terminal 20. The mobile terminal 20 has a touch panel 220 in which a display device and an input device are integrated. The surface on which the touch panel 220 of the mobile terminal 20 is provided is referred to as a front surface, and the surface opposite the front surface is referred to as a rear surface. The mobile terminal 20 is provided with a front-side camera 200 on the front surface.

Further, the mobile terminal 20 is also provided with a camera on the rear surface (a rear-side camera), which is omitted in FIG. 1. Furthermore, the mobile terminal 20 is provided with a ranging unit that performs range-finding using light emitted from a built-in light source for each of the front and rear surfaces (front-side and rear-side ranging units).

The mobile terminal 20 includes a communication unit that is connectable to the Internet via wireless communication. However, the connection to the Internet usually requires a contract with an Internet provider or the like, which makes it challenging to access the Internet overseas or the like where the contract is ineffective. In addition, accessing the Internet is difficult even in places where the wireless communication environment is not properly established.

An exemplary payment processing according to embodiments of the present disclosure in such a configuration is schematically described. The user 30 hands over a product that is intended to purchase to a cash register person who operates the POS register 10. The cash register person uses the input device 101 to acquire product information regarding the product (such as product identification information and price information). The POS register 10 generates a two-dimensional code indicating the acquired product information, causing a two-dimensional code image 11 that is based on the generated two-dimensional code to be displayed on the display 100.

Moreover, a quick response (OR) code (registered trademark) can be applied to the two-dimensional code generated by the POS register 10. The POS register 10 can generate other two-dimensional codes or one-dimensional barcodes, although not limited to the example described above.

The user 30 captures an image of a region that includes the two-dimensional code image 11 displayed on the display 100 of the POS register 10 using the rear-side camera of the mobile terminal 20 (step S10). The mobile terminal 20 extracts the two-dimensional code image 11 from the obtained captured image and acquires information included in the extracted two-dimensional code image 11. In other words, the rear-side camera of the mobile terminal 20 can function as a readout unit that reads out the two-dimensional code image 11. The mobile terminal 20 causes information acquired from the captured two-dimensional code image 11 (such as price information) to be displayed on the display device of the touch panel 220.

The user 30 operates the mobile terminal 20 to accept the purchase of the product, following the display on the touch panel 220. The mobile terminal 20, in response to such a user operation, authenticates the user 30 using the front-side ranging unit (a second ranging unit), the rear-side ranging unit (a first ranging unit), and the front-side camera 200. Successful authentication for the user 30 allows the mobile terminal 20 to control a light source of the rear-side ranging unit, transmitting information regarding the user to the POS register 10 using light.

The POS register 10 receives, by the light reception unit 102, light emitted from the mobile terminal 20 to acquire the user information. The POS register 10 transmits the acquired user information and the product information acquired from the input device 101 to a payment server (not illustrated). The payment server performs payment processing on the basis of the information transmitted from the POS register 10 and, upon completion of payment, notifies the POS register 10 of the completion of payment. The POS register 10 generates a two-dimensional code indicating the completion of payment and causes the two-dimensional code image 11, which is based on the generated two-dimensional code, to be displayed on the display 100.

The user 30 captures the two-dimensional code image 11 displayed on the display 100 using the rear-side camera of the mobile terminal 20. The mobile terminal 20 extracts the two-dimensional code image 11 from the obtained captured image and acquires information included in the extracted two-dimensional code image 11. The mobile terminal 20 causes the information indicating the completion of payment, which is acquired from the captured two-dimensional code image 11, to be displayed on the display device of the touch panel 220. This configuration allows the user 30 to recognize that the payment for the purchased product is completed.

As described above, the information processing system 1 according to embodiments of the present disclosure executes payment processing between the POS register 10 and the mobile terminal 20 by using the displaying and image-capturing of the two-dimensional code image 11 and the communication using light. Thus, it is possible for the user 30 to perform payment regarding the purchase of a product even if access to the Internet by the mobile terminal 20 is challenging.

### 2. Technologies Applicable to Embodiments

The technologies applicable to embodiments of the present disclosure is now described.

### 2-1. Configuration Applicable to Embodiments

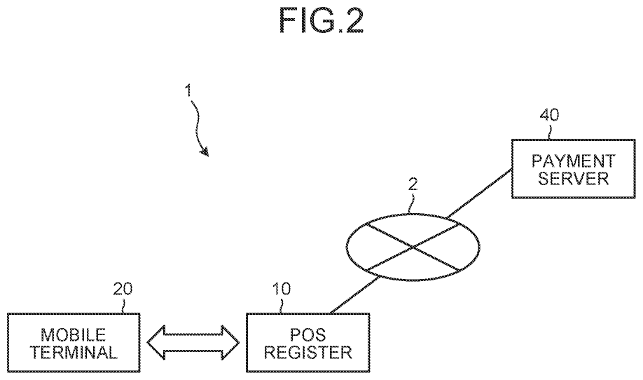

FIG. 2 is a diagram illustrating an exemplary configuration of the information processing system 1 applicable to embodiments. The information processing system 1 according to a first embodiment includes the POS register 10, the mobile terminal 20, and a payment server 40. The payment server 40 is connected to the POS register 10 via a network 2 such as the Internet.

The POS register 10 and the mobile terminal 20 are herein not necessarily electrically connected to each other via wireless or wired communication. The POS register 10 and the mobile terminal 20 communicate with each other as described with reference to FIG. 1. The communication from the POS register 10 to the mobile terminal 20 uses the two-dimensional code image 11. The communication from the mobile terminal 20 to the POS register 10 uses light emitted from the light source of the rear-side ranging unit.

Moreover, although FIG. 2 illustrates that the information processing system 1 includes one POS register 10, the configuration thereof is not limited to this example. In one example, a configuration can be employed in which a plurality of POS registers 10 connected to an in-store or on-premise network each communicates with the payment server 40 via the in-store network and the network 2. In addition, the mobile terminal 20 can be assumed to be held by each user 30 who shops at the store. Registration of identification information used to identify the user 30, who holds the mobile terminal, and information regarding financial institutions (such as bank account or credit card) used by the user 30 for payment can be assumed to be made.

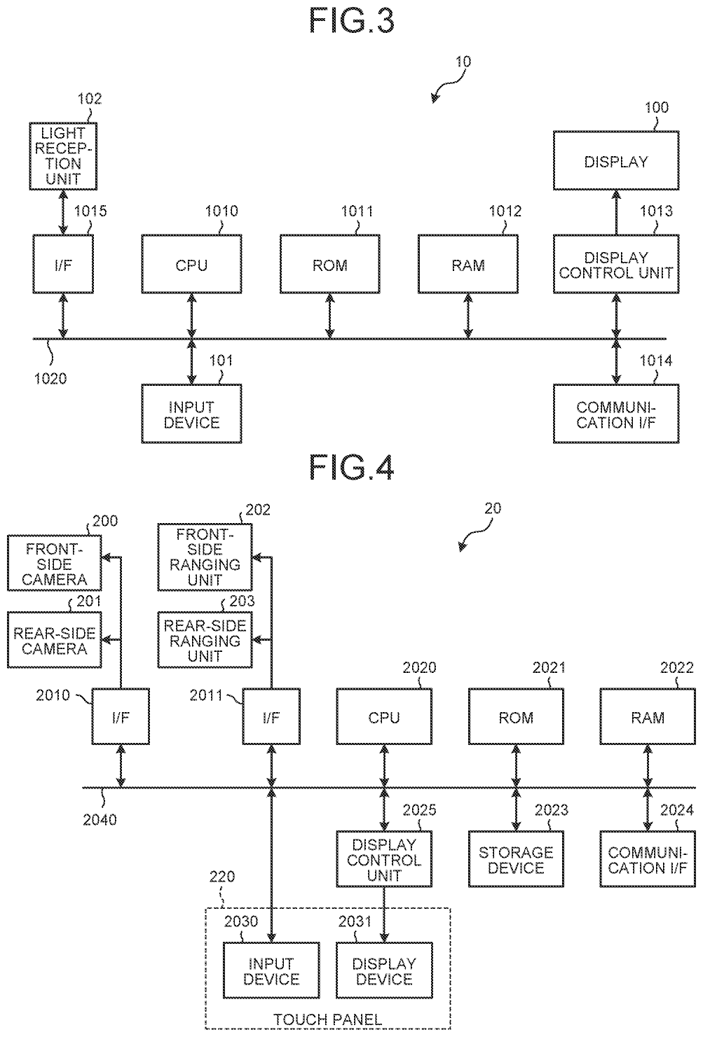

FIG. 3 is a block diagram illustrating an exemplary hardware configuration of a POS register 10 applicable to embodiments. In FIG. 3, the POS register 10 includes the display 100, the input device 101, and the light reception unit 102, as described above. The POS register 10 further includes a central processing unit (CPU) 1010, a read-only memory (ROM) 1011, a random-access memory (RAM) 1012, a display control unit 1013, a communication interface (I/F) 1014, and an I/F 1015. The input device 101, the CPU 1010, the ROM 1011, the RAM 1012, the display control unit 1013, the communication I/F 1014, and the I/F 1015 are connected to one another to be communicable mutually via a bus 1020.

The CPU 1010 uses the RAM 1012 as working memory to control the overall operation of the POS register 10 in accordance with a program stored in the ROM 1011. The display control unit 1013 generates a display signal that is displayable on the display 100 on the basis of a display control signal delivered from the CPU 1010 and delivers the generated display signal to the display 100. The display 100 displays a screen corresponding to the delivered display signal.

The input device 101 is, for example, a barcode scanner or keyboard that delivers the entered information to the CPU 1010 via the bus 1020. The communication I/F 1014 controls communication with the network 2 in accordance with an instruction from the CPU 1010. The I/F 1015 is an interface for the light reception unit 102. The light reception unit 102 receives an instruction from the CPU 1010 via the I/F 1015 and outputs an output signal corresponding to the received light. The output signal is delivered to the CPU 1010 via the I/F 1015 and the bus 1020.

As described above, the POS register 10 is configured as an information processing apparatus that includes the CPU 1010 and the memory (the ROM 1011 and the RAM 1012).

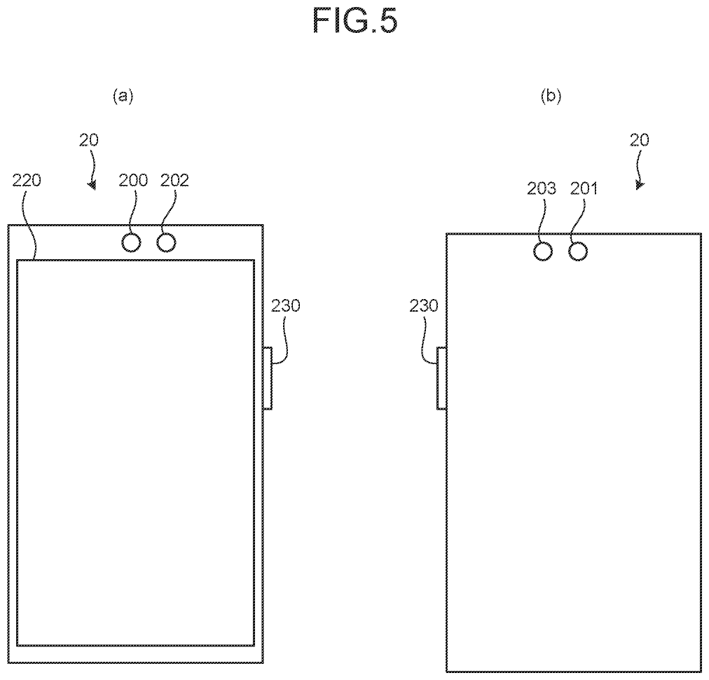

FIG. 4 is a block diagram illustrating an exemplary hardware configuration of a mobile terminal 20 applicable to embodiments. In FIG. 4, the mobile terminal 20 includes I/Fs 2010 and 2011, a CPU 2020, a ROM 2021, a RAM 2022, a display control unit 2025, a storage device 2023, and a communication I/F 2024. The mobile terminal 20 further includes a front-side camera 200, a rear-side camera 201, a front-side ranging unit 202, a rear-side ranging unit 203, an input device 2030, and a display device 2031. Among the components mentioned above, the input device 2030 and the display device 2031 are integrally formed to configure the touch panel 220.

The storage device 2023 includes, for example, a non-volatile storage medium such as flash memory.

The CPU 2020 operates by using the RAM 2022 as working memory and controls the overall operation of the mobile terminal 20 in accordance with a program stored in the ROM 2021 and the storage device 2023.

The display control unit 2025 generates the display signal that is displayable on the display device 2031 and delivers the generated display signal to the display device 2031 on the basis of the display control signal delivered from the CPU 2020. The display device 2031 displays a screen corresponding to the delivered display signal. The input device 2300 outputs a signal corresponding to the position touched by a finger or the like. The signal output from the input device 2300 is delivered to the CPU 2020 via a bus 2040. Associating each part of the screen displayed on the display device 2301 with the touched position on the input device 2300 makes it possible to virtually configure an operator portion such as a button on the touch panel 220, providing the user 30 with a user interface (UI) for operating the mobile terminal 20.

The I/F 2010 is an interface for the front-side camera 200 and the rear-side camera 201. The front-side camera 200 and the rear-side camera 201 each receive an instruction from the CPU 2020 via the I/F 2010. The front-side camera 200 and the rear-side camera 201 each capture an image and deliver the captured image to the CPU 2020 via the I/F 2010 and the bus 2040 in accordance with the instruction.

Similarly, the I/F 2011 is an interface for the front-side ranging unit 202 and the rear-side ranging unit 203. The front-side ranging unit 202 and the rear-side ranging unit 203 each receive an instruction from the CPU 2020 via the I/F 2011. The front-side ranging unit 202 and the rear-side ranging unit 203 perform range-finding in accordance with the instruction and deliver the result of the range-finding to the CPU 2020 via the I/F 2011 and the bus 2040.

FIG. 5 is a diagram schematically illustrating the external appearance of an exemplary mobile terminal 20 applicable to embodiments. In FIG. 5, section (a) illustrates the surface of the mobile terminal 20 on which the touch panel 220 is provided, and section (b) illustrates the surface of the mobile terminal 20 opposite to the surface illustrated in the section (a). As illustrated in the section (a), the side on which the touch panel 220 is provided is referred to as the front side, and the surface on which the touch panel 220 is provided is referred to as the front surface. In addition, as illustrated in the section (b), the side opposite to the front side of the mobile terminal 20 is referred to as the rear side, and the surface of the rear side of the mobile terminal 20 is referred to as the rear surface.

As illustrated in the section (a) of FIG. 5, the touch panel 220 is provided on the front surface of the mobile terminal 20. In addition, the front-side camera 200 (optical component thereof) and the front-side ranging unit 202 (light source unit and light reception unit thereof) are also provided on the front surface of the mobile terminal 20. Further, in the example of FIG. 5, a button 230 is provided as an actual operator portion on the right side of the housing of the mobile terminal 20 when viewed from the front side. The button 230 is provided, for example, to perform the operation of the power or the operation of releasing a sleep mode for the mobile terminal 20.

As illustrated in the section (b) of FIG. 5, the rear-side camera 201 (optical component thereof) and the rear-side ranging unit 203 (light source unit and light reception unit thereof) are provided on the rear surface of the mobile terminal 20.

### 2-2. Range-Finding Methods Applicable to Embodiments

A range-finding method applicable to embodiments is now schematically described. In embodiments, the front-side ranging unit 202 and the rear-side ranging unit 203 have their respective light source units and light reception units. The front-side ranging unit 202 and the rear-side ranging unit 203 each measure the distance to a measuring target. This measurement is based on the time from the emission of the light from the light source unit to the measuring target to the reception of the light reflected from the target by the light reception unit.

A description will be given of an indirect time-of-flight (ToF) technique as one such range-finding method. The indirect ToF is, for example, the technique to irradiate a measuring target with light from a source light (e.g., laser beams in the infrared region) modulated by pulse-width modulation (PWM) and receive or detect the light reflected from the measuring target with light reception elements or photodetectors, measuring the distance to the measuring target on the basis of the phase difference in the reflected light being received.

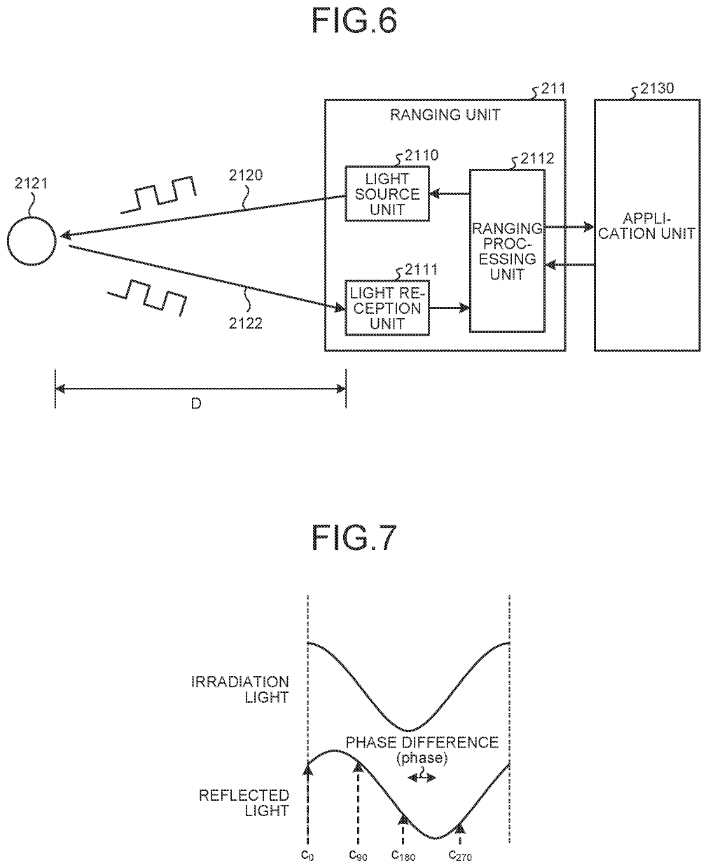

FIG. 6 is a block diagram illustrating an exemplary configuration of a ranging unit applicable to embodiments. In FIG. 6, a ranging unit 211 corresponds to each of the front-side ranging unit 202 and the rear-side ranging unit 203. An application unit 2130 is implemented, for example, by running a program on the CPU 2020. The application unit 2130 requests the ranging unit 211 to execute the range-finding and receives distance information or the like to be used as a result obtained by executing the range-finding from the ranging unit 211.

The ranging unit 211 includes a light source unit 2110, a light reception unit 2111, and a ranging processing unit 2112. The light source unit 2110 includes, for example, a light emitter that emits light with a wavelength in the infrared region and a driving circuit that drives the light emitter to emit light. A vertical-cavity surface-emitting laser (VCSEL), which is a surface light source in which a plurality of light emitters is formed in an array, is employable as the light emitter included in the light source unit 2110. This configuration is not limited to the example described above, and light-emitting diodes (LEDs) arranged in an array can be employed as the light emitter included in the light source unit 2110.

Moreover, the driving circuit is capable of driving the plurality of light emitters included in the light source unit 2110 individually or for each group obtained by dividing the plurality of light emitters. In addition, the driving circuit uses a driving signal to cause the driving circuit to drive the light emitter. This driving signal is not limited to the PWM signal and can be, for example, a rectangular wave signal that corresponds to any bit stream. This configuration enables data communication using light emitted from the light source unit 2110. Light fidelity (Li-Fi), which is one of the optical wireless communication technologies, can be employed as such data communication schemes using light.

The phrase “the light emitter of the light source unit 2110 emits light” can be herein described as “the light source unit 2110 emits light” unless otherwise specified.

The light reception unit 2111 includes, for example, a plurality of light reception elements or photodetectors and a signal processing circuit. The light reception element is capable of detecting light with a wavelength in the infrared region. The signal processing circuit outputs a pixel signal corresponding to the light detected by each of the plurality of light reception elements. The plurality of light reception elements is arranged in an array in the light reception unit 2111 to form a light receiving surface. A photodiode can be employed as the light reception element included in the light reception unit 2111. The phrase “the light reception element included in the light reception unit 2111 receives light” can be herein described as “the light reception unit 2111 receives light” unless otherwise specified.

The ranging processing unit 2112 executes ranging processing in the ranging unit 211, for example, in accordance with a ranging instruction from the application unit 2130. In one example, the ranging processing unit 2112 generates a light source control signal used to drive the light source unit 2110 and supplies the light source unit 2110 with the light source control signal. In addition, the ranging processing unit 2112 controls light reception or light detection by the light reception unit 2111 in synchronization with the light source control signal supplied to the light source unit 2110. In one example, the ranging processing unit 2112 generates an exposure control signal used to control the exposure period for the light reception unit 2111 in synchronization with the light source control signal. The ranging processing unit 2112 supplies the light reception unit 2111 with the exposure control signal. The light reception unit 2111 outputs an effective pixel signal within the exposure period the exposure control signal indicates.

The ranging processing unit 2112 calculates the distance information on the basis of a pixel signal output from the light reception unit 2111 in response to the light reception. In addition, the ranging processing unit 2112 can also generate predetermined image information on the basis of the pixel signal. The ranging processing unit 2112 delivers the distance information and image information, which are calculated and generated on the basis of the pixel signal, to the application unit 2130.

Such a configuration allows the ranging processing unit 2112 to generate the light source control signal used for driving the light source unit 2110 and supply the light source unit 2110 with the light source control signal, for example, in accordance with an instruction to execute the range-finding provided from the application unit 2130. In this example, the ranging processing unit 2112 generates the light source control signal that is modulated into a rectangular wave with a predetermined duty ratio using PWM and supplies the light source unit 2110 with the light source control signal. Simultaneously with the operations described above, the ranging processing unit 2112 controls the light reception performed by the light reception unit 2111 on the basis of the exposure control signal synchronized with the light source control signal.

In the ranging unit 211, the light source unit 2110 emits light while blinking light in accordance with a predetermined duty in response to the light source control signal generated by the ranging processing unit 2112. The light emitted from the light source unit 2110 can be emission light 2120. This emission light 2120 is reflected by, for example, a measuring target 2121, and the reflected light is received by the light reception unit 2111 as reflection light 2122. The light reception unit 2111 supplies the ranging processing unit 2112 with a pixel signal corresponding to the light reception of the reflection light 2122. Moreover, the light reception unit 2111 receives ambient light in actual cases in addition to the reflection light 2122, so the pixel signal can include a component of the ambient light as well as that of the reflection light 2122.

The ranging processing unit 2112 causes the light reception unit 2111 to execute the light reception in different phases multiple times. The ranging processing unit 2112 calculates a distance D to the measuring target on the basis of the difference between the pixel signals due to the light reception in different phases. In addition, the ranging processing unit 2112 calculates a first piece of image information and a second piece of image information. The first image information is obtained by extracting the component of the reflection light 2122 on the basis of the difference between the pixel signals. The second image information includes the component of the reflection light 2122 and the component of the ambient light. Herein, the first image information is referred to as direct reflection light information, and the second image information is referred to as RAW image information.

### (Range-Finding Using Indirect ToF Technique Applicable to Embodiments)

The range-finding using the indirect ToF technique applicable to embodiments is now described. FIG. 7 is a diagram illustrated to describe the principle of the indirect time of flight (ToF) technique. In FIG. 7, the light modulated by a sinusoidal wave is used as the emission light 2120 emitted from the light source unit 2110. The reflection light 2122 ideally becomes a sinusoidal wave with a phase difference, phase, corresponding to the distance D with respect to the emission light 2120.

The ranging processing unit 2112 performs sampling on the pixel signal obtained by receiving the reflection light 2122 multiple times with different phases to acquire a light quantity value indicating the quantity or intensity of light for each sampling. In the example of FIG. 7, light quantity values C₀, C₉₀, C₁₈₀, and C₂₇₀ are respectively obtained at phases of 0°, 90°, 180°, and 270°, each of which is out of phase by 90° with respect to the emission light 2120. In the indirect ToF technique, the distance information is calculated on the basis of a difference between the light quantity values of the pairs, which are different in phase by 180°, of the phases of 0°, 90°, 180°, and 270°.

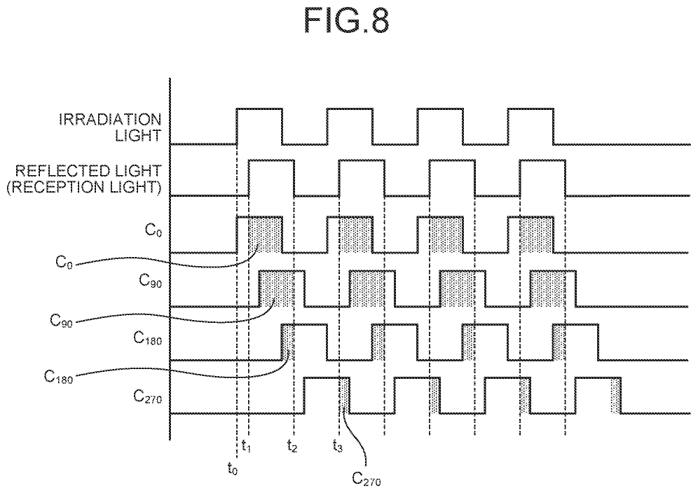

The method of calculating the distance information in the indirect ToF technique is described in more detail with reference to FIG. 8. FIG. 8 illustrates an example in which the emission light 2120 from the light source unit 2110 is a rectangular wave modulated using PWM. FIG. 8 illustrates the emission light 2120 from the light source unit 2110 and the reflection light 2122 reaching the light reception unit 2111 from the top. As illustrated in the upper part of FIG. 8, the light source unit 2110 emits the emission light 2120 by blinking periodically at a predetermined duty.

FIG. 8 also illustrates the exposure control signal in each of the phases of 0° (denoted as Φ=0°), 90° (denoted as Φ=90°), 180° (denoted as Φ=180°), and 270° (denoted as Φ=270°) of the light reception unit 2111. In one example, a period in which the exposure control signal is in a high state (High) is an exposure period in which the light reception unit 2111 outputs an effective pixel signal.

In the example of FIG. 8, the emission light 2120 is emitted from the light source unit 2110 at time to. The reflection light 2122, which is the light reflected by the measuring target from the emission light 2120, reaches the light reception unit 2111 at time t₁ after the lapse of the delay corresponding to the distance D from time t₀ to the measuring target.

On the other hand, the light reception unit 2111 starts the exposure period of the phase of 0° in synchronization with time t₂₇₀ corresponding to the emission timing of the emission light 2120 in the light source unit 2110 in accordance with the exposure control signal from the ranging processing unit 2112. Similarly, the light reception unit 2111 starts the exposure periods of phases of 90°, 180°, and 270° in accordance with the exposure control signal from the ranging processing unit 2112. The exposure period for each phase herein follows the duty ratio of the emission light 2120. Moreover, in the example of FIG. 8, the exposure periods of the respective phases are shown to be temporally parallel for the sake of description. In the light reception unit 2111, the exposure periods of the respective phases are practically specified sequentially, obtaining the light quantity values C₀, C₉₀, C₁₈₀, and C₂₇₀ of the respective phases.

In the example of FIG. 8, the arrival timings of the reflection light 2122 are time points t₁, t₂, t₃ . . . , and the light quantity value C₀ at the phase of 0° is obtained as an integral value of the received light quantities from time t₀ to the end time of the exposure period that includes the time to at the phase of 0°. On the other hand, at the phase of 180°, which is out of phase by 180° from the phase of 0°, the light quantity value C₁₈₀ is obtained as integral values of the received light quantities from the starting time point of the exposure period at the phase of 180° to the falling time point t2 of the reflection light 2122 included in the exposure period.

The light quantity values C₉₀ and C₂₇₀ are respectively obtained for the phase of 90° and the phase of 270°, which is out of phase by 180° from the phase of 90°. These light quantity values C₉₀ and C₂₇₀ are integral values of the received light quantities received during the periods in which the reflection light 2122 reaches within their respective exposure periods, which is similar to the case of the phases of 0° and 180°.

Among these light quantity values C₀, C₉₀, C₁₈₀, and Cao, differences I and Q are obtained on the basis of a combination of light quantity values that are out of phase by 180° as expressed in Equations (1) and (2) below.

$$I = {C}_{0} - {C}_{180} \qquad ( 1 )$$

$$Q = {C}_{90} - {C}_{270} \qquad ( 2 )$$

The phase difference, phase, is calculated by Equation (3) below on the basis of these differences I and Q. Moreover, in Equation (3), the phase difference, phase, is defined within the range of (0≤phase <2π).

$$phase = {tan}^{- 1} ( Q / I ) \qquad ( 3 )$$

The distance information, Depth, is calculated using the phase difference, phase, and a predetermined coefficient, range, as expressed in Equation (4) below.

$$Depth = ( phase \times range ) / 2 π \qquad ( 4 )$$

Further, it is possible to extract the component of the reflection light 2122 (information regarding the direct reflection light) from the component of the light received by the light reception unit 2111 on the basis of the differences I and Q. The direct reflected light information DiRefl is calculated using the absolute values of the respective differences I and Q, as expressed in Equation (5) below.

$$DiRef 1 = \vert I \vert + \vert Q \vert \qquad ( 5 )$$

Moreover, the direct reflected light information DiRefl is also called information of Confidence and can be expressed as Equation (6) below.

$$Confidence = √ {I}^{2} + √ {Q}^{2} \qquad ( 6 )$$

The RAW image information, RAW, can be calculated as an average value of the light quantity values C₀, C₉₀, C₁₈₀, and C₂₇₀ as expressed in Equation (7) below.

$$RAW = ( {C}_{0} + {C}_{90} + {C}_{180} + {C}_{270} ) / 4 \qquad ( 7 )$$

### 3. First Embodiment of Present Disclosure

The description is now given of a first embodiment of the present disclosure. In the first embodiment, as described above, payment processing is executed between the POS register 10 and the mobile terminal 20 by using the displaying and image-capturing of the two-dimensional code image 11 and the communication using light. Thus, it is possible for the user 30 to perform payment regarding the purchase of a product even if access to the Internet by the mobile terminal 20 is challenging.

### 3-0-1. Configuration According to First Embodiment

The configurations of the POS register 10 and the mobile terminal 20 according to the first embodiment are now described. Moreover, the hardware configurations of the POS register 10 and the mobile terminal 20 can be similarly applied to those described with reference to FIGS. 3 and 4, so the description thereof will be omitted here.

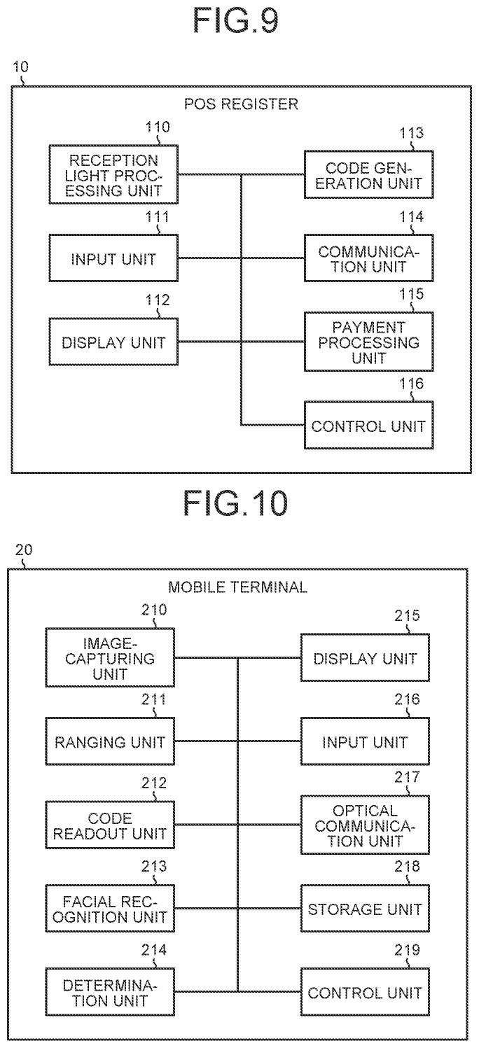

FIG. 9 is an exemplary functional block diagram illustrated to describe the functions of a POS register 10 according to a first embodiment. As illustrated in FIG. 9, the POS register 10 includes a reception light processing unit 110, an input unit 111, a display unit 112, a code generation unit 113, a communication unit 114, a payment processing unit 115, and a control unit 116.

Executing a POS-side payment processing program according to the first embodiment on the CPU 1010 implements the reception light processing unit 110, the input unit 111, the display unit 112, the code generation unit 113, the communication unit 114, the payment processing unit 115, and the control unit 116. Such arrangement is not limited to the example described above, and hardware circuits mutually cooperating can implement all or some of the reception light processing unit 110, the input unit 111, the display unit 112, the code generation unit 113, the communication unit 114, the payment processing unit 115, and the control unit 116.

The control unit 116 controls the overall operation of the POS register 10.

The reception light processing unit 110 performs signal processing on an output signal, which is output from the light reception unit 102 depending on the light reception in the light reception unit 102 under the control of the control unit 116. In one example, in the case where the light reception unit 102 receives the light modulated on the basis of any data, the reception light processing unit 110 is capable of demodulating the output signal from the light reception unit 102 to restore the output signal to the original data.

The input unit 111 acquires information entered through the input device 101 under the control of the control unit 116. The display unit 112 generates a display signal used to cause a screen to be displayed on the display 100 under the control of the control unit 116.

The code generation unit 113 converts the input data into a two-dimensional code to generate the two-dimensional code image 11 used to display the two-dimensional code under the control of the control unit 116. The code generation unit 113 can generate a QR code as the two-dimensional code. This configuration is not limited to the example described above, and the code generation unit 113 can generate a two-dimensional code image that is based on a two-dimensional code different from the QR code on the basis of the input data or generate a barcode image rather than the two-dimensional code.

The communication unit 114 performs communication via the network 2 under the control of the control unit 116. The payment processing unit 115 performs payment processing for the product information entered through the input unit 111 under the control of the control unit 116. In one example, the payment processing unit 115 transmits payment information for the product information through the communication unit 114 to the payment server 40 by communication via the network 2.

In one example, executing the POS-side payment processing program according to the first embodiment by the CPU 1010 configures the reception light processing unit 110, the input unit 111, the display unit 112, the code generation unit 113, the communication unit 114, the payment processing unit 115, and the control unit 116 as modules, for example, on the main storage region of the RAM 1012.

The POS-side payment processing program can be acquired from the outside (e.g., a server device) via the network 2 by communication through the communication I/F 1014 and can be installed on the POS register 10. This configuration is not limited to the example described above, and the POS-side payment processing program can be provided while being stored in a removable storage medium such as a compact disc (CD), digital versatile disc (DVD), or universal serial bus (USB) memory.

FIG. 10 is an exemplary functional block diagram illustrated to describe the functions of a mobile terminal 20 according to the first embodiment. As illustrated in FIG. 10, the mobile terminal 20 includes an image-capturing unit 210, a ranging unit 211, a code readout unit 212, a facial recognition unit 213, a determination unit 214, a display unit 215, an input unit 216, an optical communication unit 217, a storage unit 218, and a control unit 219.

Executing a terminal-side payment processing program according to the first embodiment on the CPU 2020 implements the image-capturing unit 210, the ranging unit 211, the code readout unit 212, the facial recognition unit 213, the determination unit 214, the display unit 215, the input unit 216, the optical communication unit 217, the storage unit 218, and the control unit 219. Such arrangement is not limited to the example described above, and hardware circuits mutually cooperating can implement all or some of the image-capturing unit 210, the ranging unit 211, the code readout unit 212, the facial recognition unit 213, the determination unit 214, the display unit 215, the input unit 216, the optical communication unit 217, the storage unit 218, and the control unit 219.

The control unit 219 controls the overall operation of the mobile terminal 20.

The image-capturing unit 210 controls an image-capturing operation independently by the front-side camera 200 and the rear-side camera 201 to acquire a captured image under the control of the control unit 219. The ranging unit 211 controls the front-side ranging unit 202 and the rear-side ranging unit 203 to independently perform range-finding on the front and rear sides, acquiring distance information as a ranging result under the control of the control unit 219.

The code readout unit 212 reads out the two-dimensional code image 11 included in the captured image obtained by the rear-side camera 201, decodes the two-dimensional code that is based on the read-out two-dimensional code image 11, and acquires information included in the two-dimensional code under the control of the control unit 219.

The facial recognition unit 213 detects a face included in the captured image obtained by the front-side camera 200 to recognize the detected face under the control of the control unit 219. The determination unit 214 uses the face recognized by the facial recognition unit 213 and the distance information acquired by the ranging unit 211 from at least one of the front-side ranging unit 202 and the rear-side ranging unit 203, determining whether or not to execute the payment processing.

The display unit 215 controls the display of a screen on the display device 2031 included in the touch panel 220 under the control of the control unit 219. The input unit 216 receives a user operation on the input device 2030 included in the touch panel and acquires operation information in response to the received user operation.

The optical communication unit 217 modulates the light emitted from the light source unit of the rear-side ranging unit 203 on the basis of the data to be transmitted, performing data transmission using light under the control of the control unit 219.

The storage unit 218 controls storing and reading data into storage media that includes the storage device 2023 in FIG. 4 under the control of the control unit 219.

In one example, executing the terminal-side payment processing program according to the first embodiment by the CPU 2020 configures the image-capturing unit 210, the ranging unit 211, the code readout unit 212, the facial recognition unit 213, the determination unit 214, the display unit 215, the input unit 216, the optical communication unit 217, the storage unit 218, and the control unit 219 as modules, for example, on the main storage region of the RAM 2022.

The terminal-side payment processing program can be acquired from the outside via the network, such as the internet, by communication through the communication I/F 2024 and can be installed on the mobile terminal 20. This configuration is not limited to the example described above, and the terminal-side payment processing program can be provided while being stored in a removable storage medium such as a compact disc (CD), digital versatile disc (DVD), or universal serial bus (USB) memory.

### 3-0-2. Details of Processing According to First Embodiment

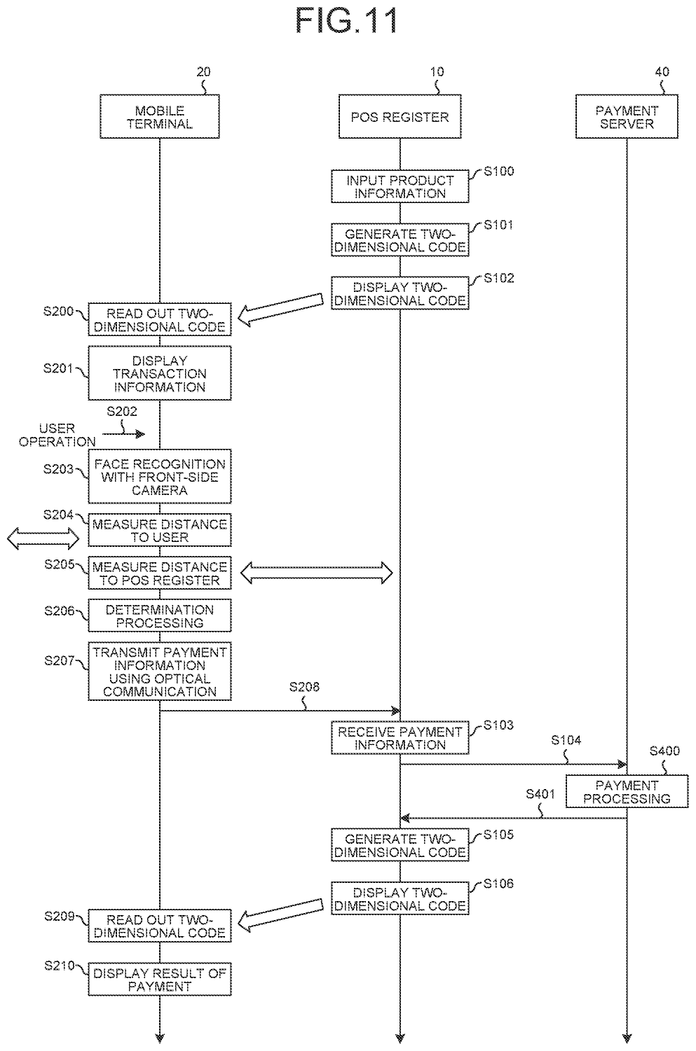

The processing according to the first embodiment is now described in detail. FIG. 11 is an exemplary flowchart illustrating payment processing according to the first embodiment. Moreover, processing steps in the POS register 10 illustrated in FIG. 11 are executed by the respective components of the POS register 10 under the control of the control unit 116. Similarly, processing steps in the mobile terminal 20 are executed by the respective components of the mobile terminal 20 under the control of the control unit 219.

Prior to the processing in the flowchart of FIG. 11, identification information of the user 30 who holds the mobile terminal 20 and the information regarding a financial institution used by the user 30 for payment (such as bank account or credit card information) are set to be registered in advance in the storage device 2023 of the mobile terminal 20.

Examples of the identification information of the user 30 can include information such as the name of the user 30 and the password (passcode) used by the user 30 to log in to the mobile terminal 20. In addition, in logging into the mobile terminal 20 using facial authentication, the identification information of the user 30 also includes facial feature information of the user 30 used for facial authentication.

The description below is given, for example, assuming a case where the user 30 purchases a product by making a payment using a two-dimensional code. In the POS register 10, product information is entered through the input device 101 (step S100) and delivered to the input unit 111. The input unit 111 delivers the input product information to the code generation unit 113 under the control of the control unit 116. The code generation unit 113 generates a two-dimensional code (QR code in this example) on the basis of the delivered product information under the control of the control unit 116 (step S101).

The code generation unit 113 delivers the generated two-dimensional code to the display unit 112. The display unit 112 generates the two-dimensional code image 11 used to display the two-dimensional code on the basis of the two-dimensional code delivered from the code generation unit 113 and causes the generated two-dimensional code image 11 to be displayed on the display 100 (step S102).

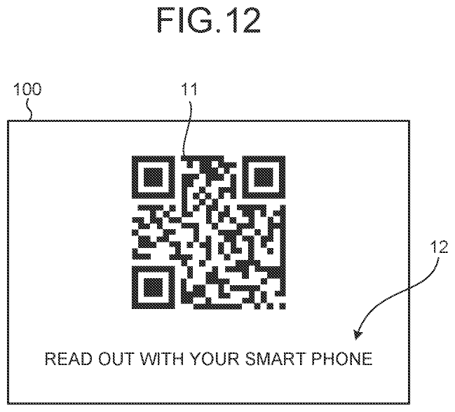

FIG. 12 is a schematic diagram illustrating an example of a two-dimensional code image 11 displayed on a display 100 of the POS register 10 applicable to the first embodiment. The two-dimensional code image 11 (QR code image that is based on QR code in this example) is displayed in a size that can be easily recognized upon being captured by the rear-side camera 201 of the mobile terminal 20. Furthermore, in the example of FIG. 12, a message 12 is displayed on the display 100 to prompt the user 30 to read out the two-dimensional code image 11.

The user 30 starts the terminal-side payment processing program according to the first embodiment on the mobile terminal 20. Then, the user 30 captures the two-dimensional code image 11 displayed on the display 100 of the POS register 10 in the mobile terminal 20 in step S102 with the rear-side camera 201 of the user's mobile terminal 20 and reads out the two-dimensional code that is based on the two-dimensional code image 11 (step S200).

In other words, in the mobile terminal 20, the two-dimensional code image 11 is captured by the image-capturing unit 210 in response to the operation of the user 30. The image-capturing unit 210 delivers the captured image being obtained by capturing the two-dimensional code image 11 to the code readout unit 212. The code readout unit 212 extracts and analyzes the two-dimensional code image 11 from the captured image that is delivered from the image-capturing unit 210 to acquire the two-dimensional code. Then, the code readout unit 212 obtains the product information from the extracted two-dimensional code.

The mobile terminal 20 causes the touch panel 220 (the display device 2031) to display transaction information that includes the product information of the product purchased by the user 30 based on the read-out two-dimensional code by the display unit 215 (step S201).

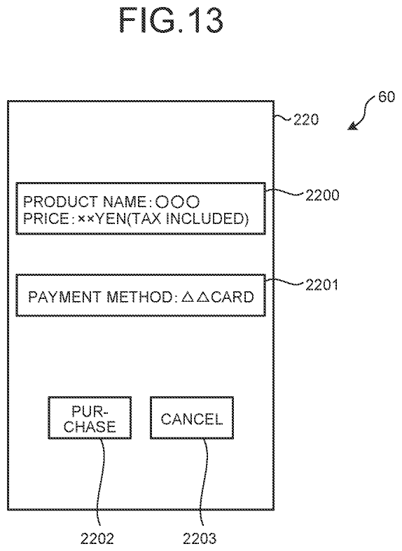

FIG. 13 is a schematic diagram illustrating an example of a transaction information screen displayed on a touch panel 220 of the mobile terminal 20 applicable to the first embodiment. The example of FIG. 13 illustrates a transaction information screen 60 that includes display regions 2200 and 2201 and graphical buttons 2202 and 2203 arranged on the transaction information screen 60.

The display region 2200 is an area in which product information (Product name, price, etc.) based on the read-out two-dimensional code is displayed. Furthermore, the display region 2201 is an area in which a payment method based on information on a financial institution used for payment by the user 30 (payment method), registered in the mobile terminal 20, is displayed. The transaction information includes, for example, the product information and a method indicating a payment method. The transaction information may further include identification information for identifying the user 30, and the like.

The button 2202 is used to instruct the payment to proceed on the contents displayed in the display regions 2200 and 2201 in response to the user's operation on the button 2202. The button 2203 is used to cancel the payment in response to the user's operation.

If the user 30 operates the button 2202 (step S202) to instruct the payment to proceed, the mobile terminal 20 captures the face of the user 30 with the front-side camera 200 to recognize the user 30 on the basis of the face included in the captured image (step S203).

In one example, in the mobile terminal 20, the image-capturing unit 210 performs image-capturing with the front-side camera 200 in response to the operation of the button 2202 to acquire the captured image. The image-capturing unit 210 delivers the acquired captured image to the facial recognition unit 213. The facial recognition unit 213 recognizes the face included in the captured image delivered from the image-capturing unit 210.

If the user 30 is recognized by the mobile terminal 20 in step S203, the ranging unit 211 of the mobile terminal 20 measures a distance D_{USER} between the mobile terminal 20 and the user 30 with the front-side ranging unit 202 in step S204. Furthermore, the ranging unit 211 of the mobile terminal 20 measures a distance D_{POS} between the mobile terminal 20 and the POS register 10 with the rear-side ranging unit 203 in step S205.

In the mobile terminal 20, in step S206, the determination unit 214 authenticates the user 30 and determines whether or not to execute the payment processing on the basis of the face recognized in step S203 and the distances D_{USER} and D_{POS} respectively obtained in steps S204 and S205.

In one example, the determination unit 214 extracts information regarding facial features recognized in step S203 and compares the extracted facial feature information with the pre-registered facial feature information of the user 30 in the mobile terminal 20, authenticating the user 30.

Furthermore, the determination unit 214 performs the determination of comparison between a threshold and the distances D_{USER} and D_{POS}. Then, the determination unit 214 determines to execute the payment processing concerned in the case where the user 30 is authenticated using facial recognition on the basis of the captured image and the distances D_{USER} and D_{POS} are equal to or less than the threshold.

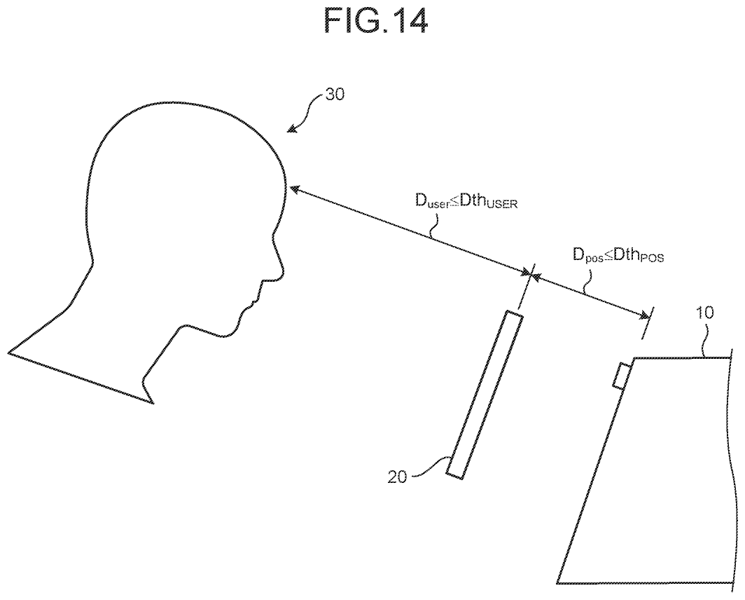

FIG. 14 is a schematic diagram illustrated to describe the determination of comparison between a threshold and the distances D_{USER} and D_{POS} according to the first embodiment. The determination unit 214 compares the distance D_{USER} that distance to the user 30 measured by the ranging unit 211 with a threshold Dth_{USER} (a second threshold). Further, the determination unit 214 compares the distance D_{POS} that is distance to the POS register 10 measured by the ranging unit 211 with a threshold Dth_{POS} (a first threshold).

In the case where the authentication of the user 30 by the face recognition is successful, the determination unit 214 determines to execute the payment processing in the case where the distance D_{USER} is equal to or less than the threshold Dth_{USER} and the distance D_{POS} is equal to or less than the threshold Dth_{POS}.

That is, when the distance D_{POS} is equal to or less than the threshold Dth_{POS}, at the time of performing optical communication from the mobile terminal 20 to the POS register 10, it is possible to prevent light by optical communication from being diffused and received by another equipment different from the POS register 10 as a target, and to suppress interference from other optical communication. Furthermore, if the distance D_{USER} is equal to or less than the threshold Dth_{USER} and the face of the user 30 is recognized on the basis of the captured image captured by the front-side camera 200 of the mobile terminal 20, it can be determined that the user 30 himself/herself is operating the mobile terminal 20. Therefore, by performing the determination of comparison between a threshold and the distances D_{USER} and D_{POS}, it is possible to more securely execute optical communication from the mobile terminal 20 to the POS register 10.

Here, the threshold Dth_{USER} and the threshold Dth_{POS} may be the same value or different values. When the threshold Dth_{USER} and the threshold Dth_{POS} are set to different values, the threshold Dth_{USER} is preferably set to a larger value than the threshold Dth_{POS}.

Returning to the description of FIG. 11, in a case where the mobile terminal 20 determines to execute the payment processing by the determination processing in step S206, in the next step S207, the optical communication unit 217 transmits the payment information including the transaction information to the POS register 10 by using optical communication. That is, the mobile terminal 20 causes the optical communication unit 217 to modulate the light emitted by the light source unit included in the rear-side ranging unit 203 on the basis of the payment information and emit the modulated light. As a modulation scheme at this time, a modulation scheme defined by Li-Fi can be applied.

The payment information is transmitted to the POS register 10 via the space between the mobile terminal 20 and the POS register 10 by optical communication using light emitted from the rear-side ranging unit 203 (step S208), and received by the light reception unit 102 of the POS register 10 (step S103).

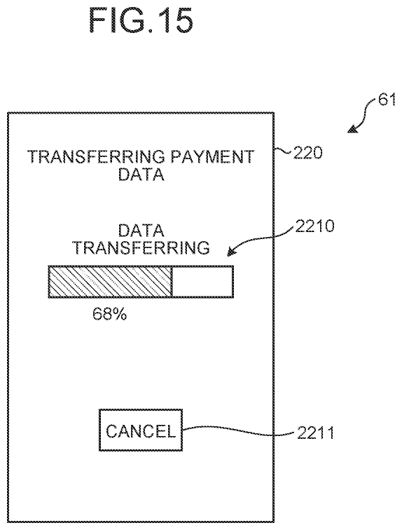

Here, the mobile terminal 20 can display the transmission status of the payment information on the touch panel 220 (display device 2013). FIG. 15 is a schematic diagram illustrating an example of a screen for transmission indicating the transmission status of payment information displayed on the touch panel 220 of the mobile terminal 20 applicable to the first embodiment. In the example of FIG. 15, a transmission screen 61 includes a progress bar 2210 indicating a progress status of data (payment information) transmission and a button 2211. The button 2211 is a button for stopping the transmission of the payment information according to the operation. The user 30 can determine whether or not it is possible to move the mobile terminal 20 by checking the progress status of the payment information displayed on the progress bar 2210.

The POS register 10 demodulates, by the reception light processing unit 110, the light emitted from the mobile terminal 20 and received by the light reception unit 102, and restores the payment information. The POS register 10 transmits the restored payment information to the payment server 40 via the network 2 by the communication unit 114 (step S104). The payment server 40 performs payment processing according to the payment information transmitted from the POS register 10 (step S400), and transmits a result of the payment processing to the POS register 10 via the network 2 (step S401). Note that the payment processing result includes information on whether the payment has succeeded.

The POS register 10 receives the payment processing result transmitted from the payment server 40 by the communication unit 114, and generates a two-dimensional code indicating the received payment processing result by the code generation unit 113 (step S105). The code generation unit 113 delivers the generated two-dimensional code to the display unit 112. The POS register 10 generates the two-dimensional code image 11 used to display the two-dimensional code on the basis of the two-dimensional code delivered from the code generation unit 113 and causes the display unit 112 to display the generated two-dimensional code image 11 on the display 100 (step S106).

The mobile terminal 20 captures, according to the operation of the user 30, for example, the two-dimensional code image 11 displayed on the display 100 of the POS register 10 in step S105 with the rear-side camera 201 of own mobile terminal 20 and reads out the two-dimensional code that is based on the two-dimensional code image 11 (step S209). The mobile terminal 20 causes the touch panel 220 (the display device 2031) to display the result of payment based on the read-out two-dimensional code by the display unit 215 (step S210).

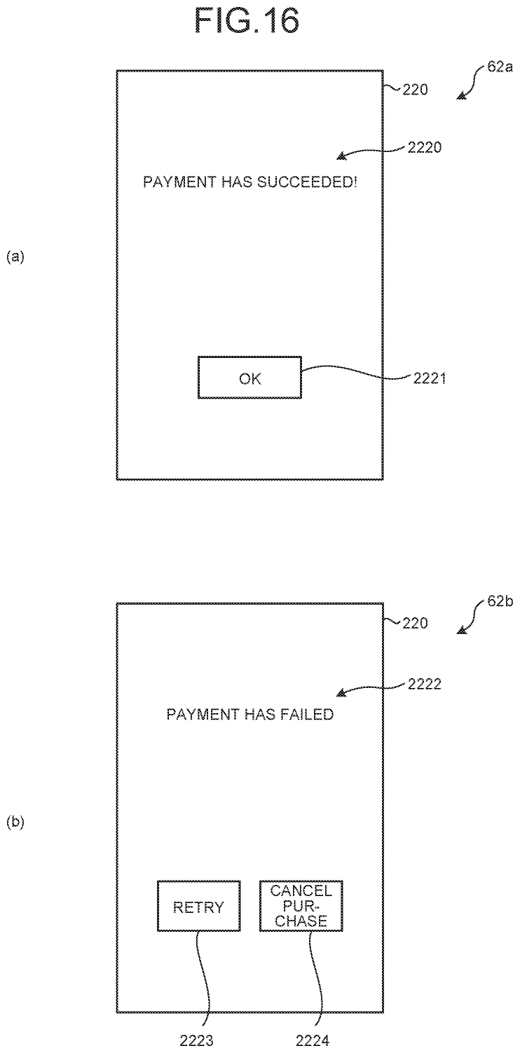

FIG. 16 is a schematic diagram illustrating an example of a payment result screen illustrating the result of payment displayed on the touch panel 220 of the mobile terminal 20 applicable to the first embodiment. In FIG. 16, a section (a) illustrates an example of a payment result screen 62a in a case where the payment has succeeded, and a section (b) illustrates an example of a payment result screen 62b in a case where the payment has failed.

In the payment result screen 62a illustrated in the section (a) of FIG. 16, a message 2220 indicating that the payment has succeeded and a button 2221 are arranged. The button 2221 is a button for ending a series of payment processes in accordance with an operation. By operating the button 2221, for example, the terminal-side payment processing program executed in the mobile terminal 20 is terminated.

In the payment result screen 62b illustrated in the section (b) of FIG. 16, a message 2222 indicating that the payment has failed and buttons 2223 and 2224 are arranged. The button 2223 is a button for retrying a series of payment processes. In a case where the button 2223 is operated, for example, the payment processing is retried from the product information input in step S100. The button 2224 is a button for canceling the payment. By operating the button 2224, for example, the terminal-side payment processing program executed in the mobile terminal 20 is terminated.

Note that the mobile terminal 20 can further display a message indicating the cause related to the payment failure (failed in optical communication, unavailable payment account, etc.) on the payment result screen 62b.

As described above, in the information processing system 1 according to the first embodiment, communication is performed between the POS register 10 and the mobile terminal 20 by using the two-dimensional code image 11 and the optical communication, and the payment can be completed. Therefore, even in an environment where it is difficult to access the Internet by the mobile terminal 20, the payment processing can be executed.

Note that, in the above description, the range-finding on the POS register 10 and the range-finding on the user 30 are executed using the indirect ToF, but the configuration thereof is not limited to this example. That is, as long as the range-finding method according to the first embodiment is a range-finding method that performs range-finding using light emitted from a light source, another range-finding method can be applied. Examples of such a range-finding method include a direct ToF method, an active stereo method, and a structured light method.

Furthermore, in the above description, the mobile terminal 20 performs range-finding on the user 30 and range-finding on the POS register 10 in steps S204 and S205, but the configuration thereof is not limited to this example. For example, only one of the range-finding on the user 30 in step S204 and the range-finding on the POS register 10 in step S205 may be executed.

Furthermore, in the above description, the mobile terminal 20 performs range-finding on the POS register 10 only in step S205, but the configuration thereof is not limited to this example. For example, the mobile terminal 20 can perform the range-finding on the POS register 10 also at the time of reading out the two-dimensional code image 11 in step S200.

That is, the mobile terminal 20 executes range-finding at least once before the transmission of the payment information using optical communication in steps S207 and S208 is completed.

### 3-1. First Modification of First Embodiment

A first modification of first embodiment is now described. In the first embodiment described above, the mobile terminal 20 reads out the two-dimensional code image 11 displayed on the display 100 of the POS register 10 by capturing the image using the rear-side camera 201, but the method of reading out the two-dimensional code image 11 is not limited to this method.

In the first modification of the first embodiment, the two-dimensional code image 11 displayed on the display 100 of the POS register 10 is read out with the rear-side ranging unit 203 of the mobile terminal 20. More specifically, in the first modification of the first embodiment, for example, in steps S200 and S209 of FIG. 11, the confidence information is extracted from the component of the light received by the light reception unit of the rear-side ranging unit 203 by the above-described Equations (5) and (6), and the two-dimensional code image 11 displayed on the display 100 is read out using the confidence information.

That is, as described above, the confidence information is the directly reflected light component extracted from the component of the light received by the light reception unit. Therefore, for example, when infrared light is used as the light source light, the confidence information is infrared light information. The two-dimensional code image 11 can be read out by extracting the confidence information from each light received by each of the plurality of light reception elements arranged in an array included in the light reception unit of the rear-side ranging unit 203 and arranging the confidence information corresponding to each of the plurality of extracted light reception elements in an array.

As described above, by reading out the two-dimensional code image 11 using the rear-side ranging unit 203, the payment process can be executed without starting the rear-side camera 201, and the power consumption in the mobile terminal 20 can be reduced.

### 3-2. Second Modification of First Embodiment

A second modification of the first embodiment is now described. The second modification of the first embodiment is an example in which the number of driven light reception elements of the rear-side ranging unit 203 is different between the case of reading out the two-dimensional code image 11 and the case of performing the range-finding in the configuration of the above-described first modification. More specifically, for example, the number of drive elements in the case of performing the range-finding in step S205 of FIG. 11 is made smaller than the number of drive elements in the case of reading out the two-dimensional code image 11 in steps S200 and S209.

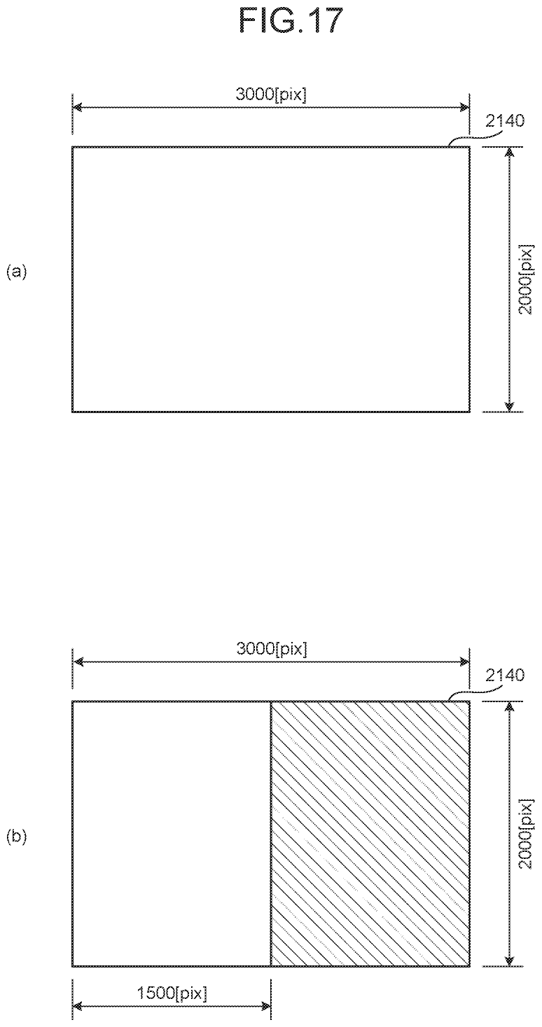

FIG. 17 is a schematic diagram illustrating an example of varying the number of light reception elements to be driven in the rear-side ranging unit 203 according to a second modification of the first embodiment. Here, as an example, it is assumed that the light reception unit of the rear-side ranging unit 203 includes 3000 [pix]×2000 [pix] light reception elements arranged in an array with one light reception element as one pixel (pix).

A section (a) in FIG. 17 illustrates an example of driving in a case where the two-dimensional code image 11 is read out. In this way, in the case of reading out the two-dimensional code image 11, for example, all the light reception elements of 3000 [pix]×2000 [pix] are driven. That is, in a case where the two-dimensional code image 11 is read out, the resolution of the light reception unit is increased.

A section (b) in FIG. 17 illustrates an example of driving in a case where range-finding is performed. As described in the first embodiment, the rear-side ranging unit 203 performs range-finding on the POS register 10 in the payment processing. In this case, it is sufficient that the distance to the POS register 10 can be acquired, and high resolution is unnecessary. Therefore, for example, the light reception elements of 1500 [pix], which is a half of 3000 [pix] in the horizontal direction in the drawing, are driven, and the remaining light reception elements (indicated by hatching in the drawing) are not driven.

Note that the example illustrated in the section (b) of FIG. 17 is an example, and the configuration thereof is not limited to this example. For example, in the case of range-finding related to the payment processing, less than ½ (for example, ⅓) of the light reception elements of 3000 [pix]×2000 [pix] may be driven. In addition, the division direction of driving and non-driving of the plurality of light reception elements is not limited to the vertical direction illustrated in the section (b) of FIG. 17, and the light reception elements may be divided in the horizontal direction (that is, vertically), or the arrangement in an array of the light reception elements may be divided so as not to be divided in the vertical or horizontal direction like the central portion and the peripheral portion.

As described above, the power consumption in the mobile terminal 20 can be reduced by making the number of driven light reception elements of the rear-side ranging unit 203 different between the case of reading out the two-dimensional code image 11 and the case of performing the range-finding.

### 3-3. Third Modification of First Embodiment

A third modification of first embodiment is now described. The third modification of the first embodiment is an example in which, in the payment processing, the light irradiation area by the rear-side ranging unit 203 is made different between a case of performing range-finding and a case of reading out the two-dimensional code image 11. More specifically, the light irradiation area by the rear-side ranging unit 203 is narrowed in a case where the payment information is transmitted by optical communication in steps S207 and S208 in FIG. 11, as compared with a case where range-finding is performed in step S205 in FIG. 11, for example.

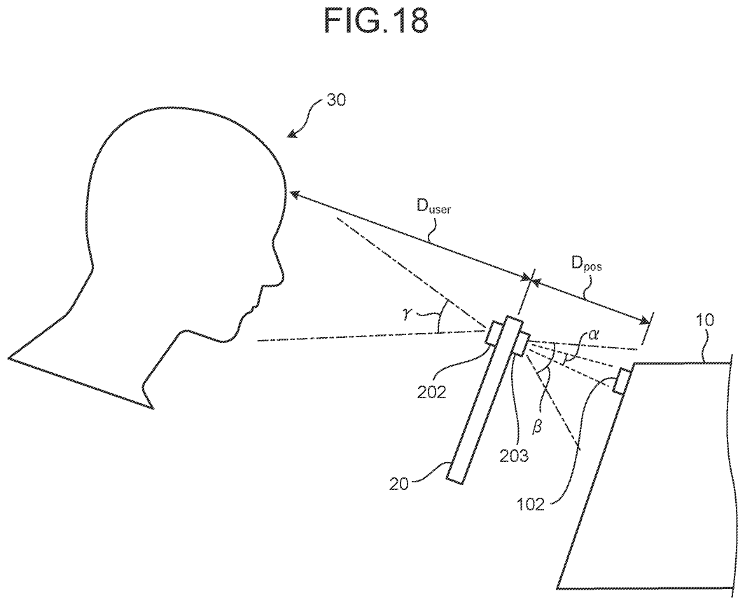

FIG. 18 is a schematic diagram illustrated to describe a light irradiation area by a rear-side ranging unit 203 according to a third modification of the first embodiment. In FIG. 18, in a case where a light irradiation area (irradiation angle) by the rear-side ranging unit 203 in a case where the payment information is transmitted by optical communication is an angle α, and a light irradiation area (irradiation angle) by the rear-side ranging unit 203 in a case where the range-finding is performed is an angle β, it is assumed that an angle α<an angle β. This makes it possible to more securely transmit the payment information by optical communication.

The light irradiation area by the rear-side ranging unit 203 can be changed by, for example, changing the number of driving light emitters in the light source unit included in the rear-side ranging unit 203. For example, in a case where range-finding is performed, all the plurality of light emitters arranged in an array in the light source unit are driven, and in a case where information is transmitted by optical communication, only the light emitters included in a partial region of the array among the plurality of light emitters are driven. Alternatively, the light irradiation area can be changed by controlling the optical system of the light source unit.

Note that the light irradiation area (angle γ) by the light source unit of the front-side ranging unit 202 is preferably set such that, for example, a main part of the face of the user 30 is imaged at the distance D_{USER}.

### 3-4. Fourth Modification of First Embodiment

A fourth modification of first embodiment is now described. The fourth modification of the first embodiment is an example in which the light intensity at the time of transmitting information from the mobile terminal 20 to the POS register 10 by optical communication is changed according to the distance between the mobile terminal 20 and the POS register 10.

More specifically, as the distance D_{POS} measured in step S205 in FIG. 11 is shorter, the mobile terminal 20 decreases the intensity of light emitted from the light source unit of the rear-side ranging unit 203 when transmitting the payment information by optical communication in steps S207 and S208. In this way, light emitted from the light source unit of the rear-side ranging unit 203 by optical communication is prevented from being diffused and received by another equipment different from the POS register 10 as a target, and more secure communication can be performed.

### 3-5. Fifth Modification of First Embodiment

A fifth modification of first embodiment is now described. The fifth modification of the first embodiment is an example in which the position of the light reception unit 102 in the POS register 10 is specified on the basis of a captured image obtained by imaging the POS register 10 by a sensor different from the rear-side ranging unit 203, for example, the rear-side camera 201. When the rear-side ranging unit 203 transmits information by optical communication, light emitted by the rear-side ranging unit 203 by optical communication is irradiated toward the specified position of the light reception unit 102.

More specifically, the mobile terminal 20 causes the rear-side camera 201 to capture an image of the POS register 10 at any timing from step S200 to step S205 in FIG. 11. The mobile terminal 20 recognizes the light reception unit 102 from the captured image obtained by capturing the POS register 10 and obtains the position thereof. For example, it is conceivable that the mobile terminal 20 executes matching processing using an image of the light reception unit 102 registered in advance on the captured image to specify the position of the light reception unit 102 in the captured image. The position of the light reception unit 102 may be a position (coordinates) in the captured image or a relative position with respect to the image of the POS register 10 included in the captured image.

When transmitting the payment information by optical communication in steps S207 and S208 of FIG. 11, the mobile terminal 20 emits light of the optical communication toward the specified position of the light reception unit 102.

The control of the light emission direction by the rear-side ranging unit 203 can be performed, for example, by controlling the position of the light emitter driven in the light source unit of the rear-side ranging unit 203. For example, as illustrated in FIG. 1, in the POS register 10, in a case where the light reception unit 102 is located in the upper portion of the display 100, one or a plurality of light emitters arranged in the upper portion of the array among the plurality of light emitters arranged in the array in the light source unit is driven. Alternatively, it is also possible to control the emission direction of light by controlling the optical system included in the light source unit.

Thus, when the rear-side ranging unit 203 transmits information by optical communication, light emitted by the rear-side ranging unit 203 by optical communication is irradiated toward the specified position of the light reception unit 102, so that more secure communication can be performed.

### 3-6. Sixth Modification of First Embodiment

A sixth modification of first embodiment is now described. A sixth modification of the first embodiment is an example in which a two-dimensional code image 11 indicating product information is displayed on a product shelf or the like on which products are displayed.

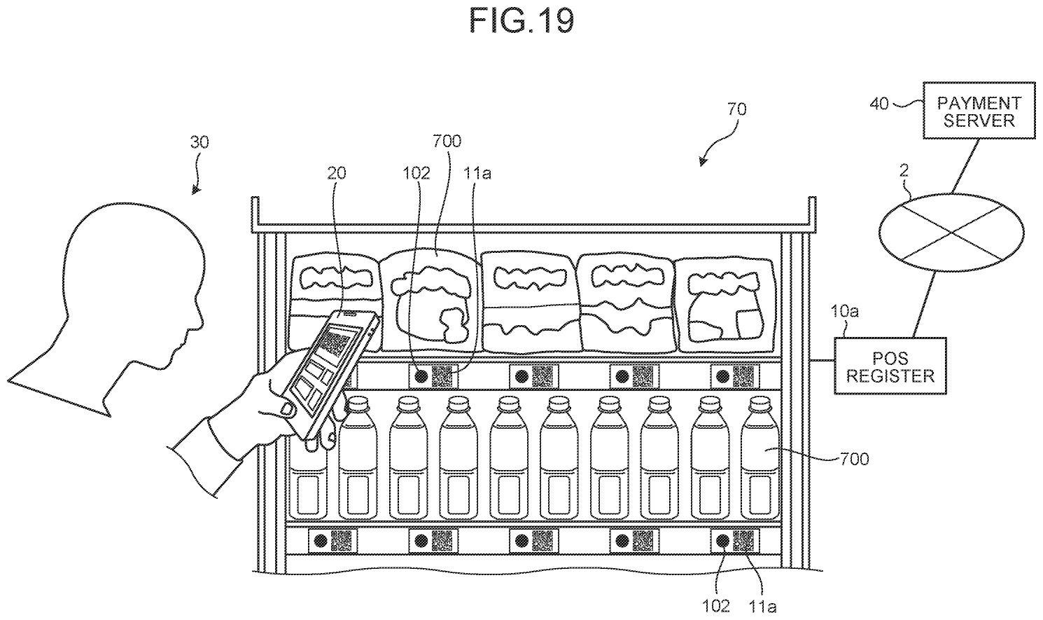

FIG. 19 is a schematic diagram illustrating an exemplary configuration of an information processing system according to a sixth modification of the first embodiment. In FIG. 19, a plurality of products 700 are displayed on a product shelf 70, and a light reception unit 102 and a small display device for displaying a two-dimensional code image 11a indicating product information are provided corresponding to the products 700. Each light reception unit 102 transmits an output signal corresponding to the received light to the POS register 10a. Further, the POS register 10a transfers the two-dimensional code image 11a to the display device and causes the display device to display the two-dimensional code image 11a.

Note that the POS register 10a is connected to the payment server 40 via the network 2, similarly to the information processing system 1 illustrated in FIG. 2.

Even in such a configuration, the payment processing according to the flowchart of FIG. 11 described above is possible. In this case, the processing of inputting the product information and generating the two-dimensional code in steps S100 and S101 is executed in advance corresponding to each product 700. By applying the sixth modification of the first embodiment, the user 30 can perform payment using the two-dimensional code image 11a for each product 700 displayed on the product shelf 70 even in an environment where the mobile terminal 20 of own is difficult to access the Internet.

### 3-7. Seventh Modification of First Embodiment

A seventh modification of first embodiment is now described. A seventh modification of the first embodiment is an example in which a two-dimensional code image 11 indicating product information is displayed in a cart in which the user 30 puts products.

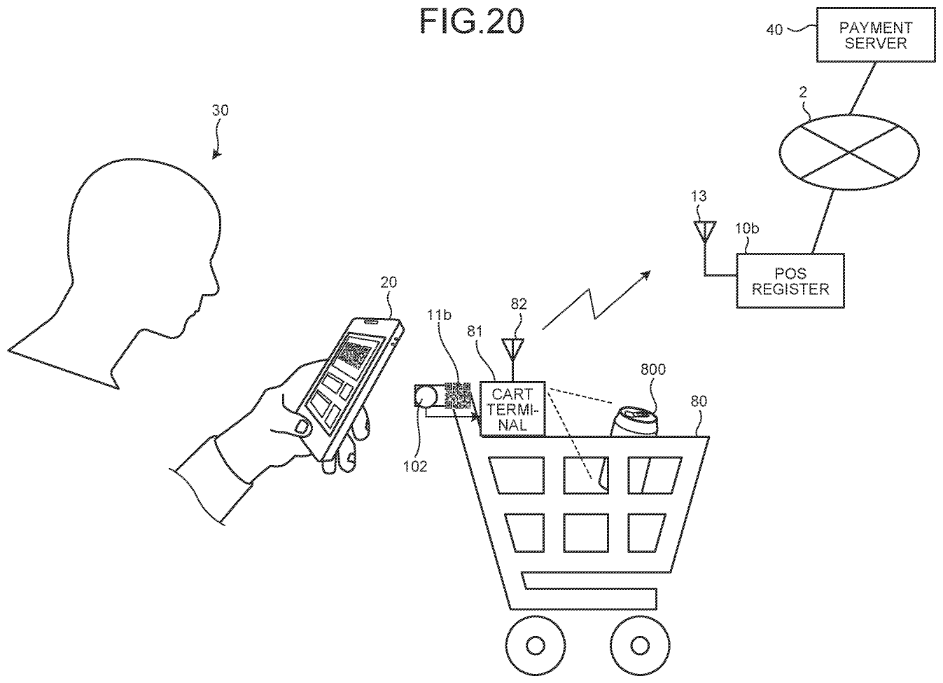

FIG. 20 is a schematic diagram illustrating an exemplary configuration of an information processing system according to a seventh modification of the first embodiment. In FIG. 20, a cart terminal 81 is mounted on a cart 80 into which a product 800 is put by the user 30. The cart terminal 81 can wirelessly communicate with the POS register 10b similarly provided with the antenna 13 using the antenna 82. The POS register 10b is connected to the payment server 40 via the network 2, similarly to the information processing system 1 illustrated in FIG. 2.

In the cart 80, a light reception unit 102 and a small display device for displaying a two-dimensional code image 11b indicating product information, each of which is connected to the cart terminal 81, are provided. The cart terminal 81 transmits an output signal output according to the received light delivered from the light reception unit 102 to the POS register 10b by wireless communication.

Furthermore, the cart terminal 81 includes a detection unit that detects the product information of the product 800 put in the cart 80. For example, the cart terminal 81 corresponds to a radio frequency identifier (RFID), reads out an integrated circuit (IC) tag that is attached to each product 800 and stores product information of the product 800, and acquires the product information of the product 800. Such arrangement is not limited to the example described above, and the cart terminal 81 may include a camera, image the product 800 put in the cart 80, and recognize the product 800 on the basis of the captured image.

The cart terminal 81 generates the two-dimensional code image 11b on the basis of the product information of the product 800 put into the cart 80 and recognized. The cart terminal 81 causes a small display device provided in the cart 80 for displaying the two-dimensional code image 11b to display the generated two-dimensional code image 11b.

Even in such a configuration, the payment processing according to the flowchart of FIG. 11 described above is possible. Note that, in this case, the processing of inputting the product information in step S100 is performed by the cart terminal 81 reading out the product information of the product 800 put into the cart 80 from, for example, the IC tag attached to the product 800. By applying the seventh modification of the first embodiment, the user 30 can perform payment using the two-dimensional code image 11b for each product 800 put into the cart 80 even in an environment where the mobile terminal 20 of own is difficult to access the Internet.

Note that the first to seventh modifications described above can be implemented by combining a plurality of modifications within a range not contradictory to each other.

### 4. Second Embodiment of Present Disclosure

The description is now given of a second embodiment of the present disclosure. The second embodiment is an example in which an encryption process is incorporated with respect to the above-described first embodiment. More specifically, in the flowchart of FIG. 11 described above, the payment information transmitted from the mobile terminal 20 to the POS register 10 by optical communication in steps S207 and S208 is encrypted.

### 4-0-1. Configuration According to Second Embodiment

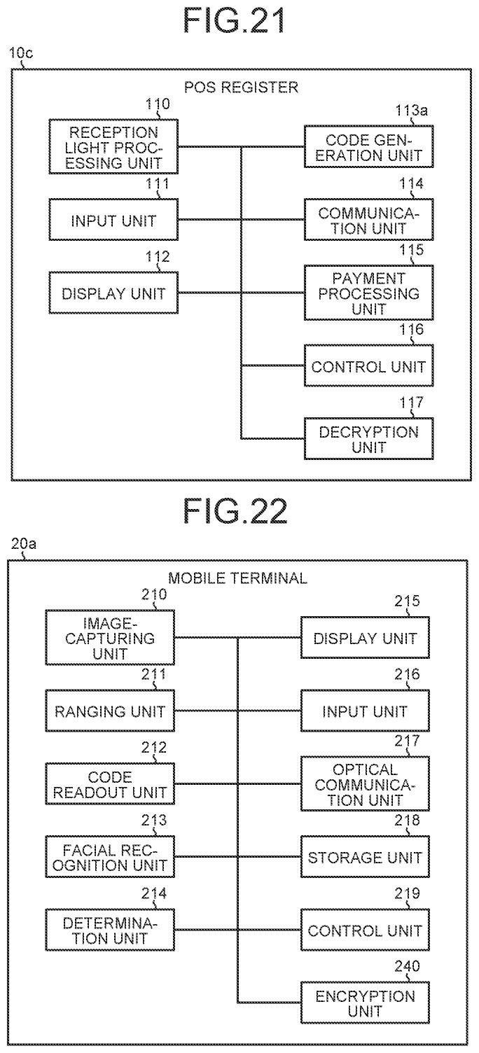

FIG. 21 is an exemplary functional block diagram illustrated to describe the functions of a POS register 10c according to a second embodiment. In FIG. 21, the POS register 10c has a configuration in which a decryption unit 117 is added to the POS register 10 according to the first embodiment illustrated in FIG. 9. The decryption unit 117 decrypts data encrypted using a public key, using a private key corresponding to the public key. In addition, the code generation unit 113a generates a two-dimensional code for displaying the two-dimensional code image 11 to be presented to the mobile terminal 20 at the beginning of the payment processing, together with the product information, including the public key.

The function of each unit of the POS register 10c other than the code generation unit 113a and the decryption unit 117 is equivalent to the function of each corresponding unit of the POS register 10 according to the first embodiment illustrated in FIG. 9, and thus, the description thereof is omitted here.

FIG. 22 is an exemplary functional block diagram illustrated to describe the functions of a mobile terminal 20a according to the second embodiment. In FIG. 22, the mobile terminal 20a has a configuration in which an encryption unit 240 is added to the mobile terminal 20 according to the first embodiment illustrated in FIG. 10. The encryption unit 240 encrypts data using a public key.

The function of each unit of the mobile terminal 20a other than the encryption unit 240 is equivalent to the function of each corresponding unit of the mobile terminal 20 according to the first embodiment illustrated in FIG. 10, and thus, the description thereof is omitted here.

### 4-0-2. Details of Processing According to Second Embodiment

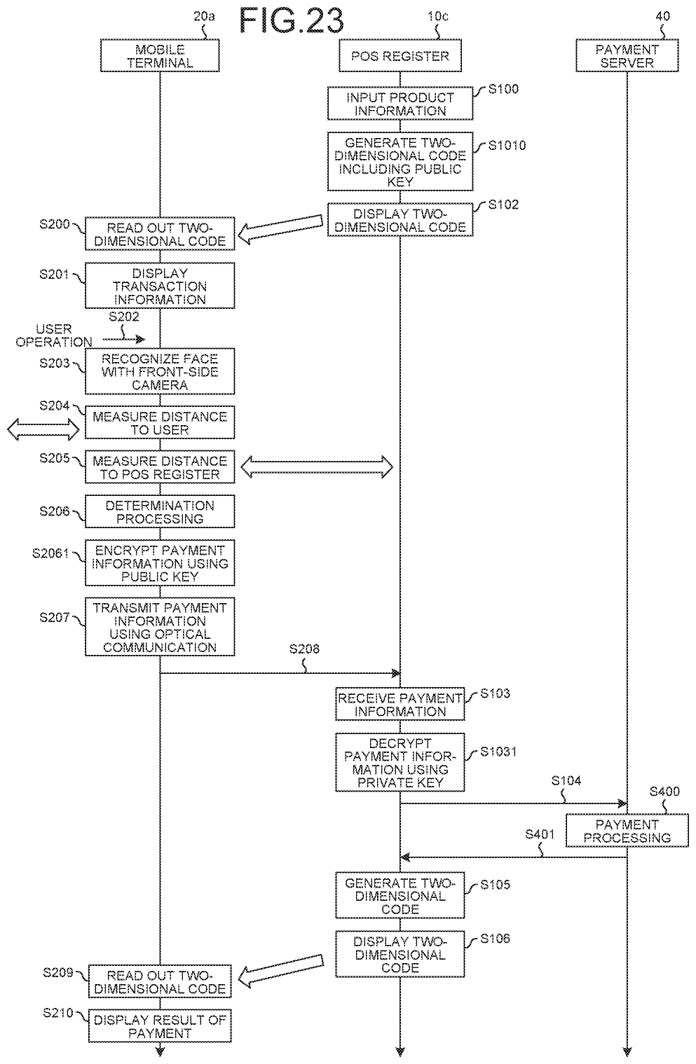

The processing according to the first embodiment is now described in detail. FIG. 23 is an exemplary flowchart illustrating payment processing according to the second embodiment. Since the processing in the flowchart illustrated in FIG. 23 is generally equivalent to the processing in the flowchart according to the first embodiment illustrated in FIG. 11, the following description will focus on portions different from the processing in the flowchart of FIG. 11.

Similarly to the description above, prior to the processing in the flowchart of FIG. 23, identification information of the user 30 who holds the mobile terminal 20 and the information regarding a financial institution used by the user 30 for payment (such as bank account or credit card information) are set to be registered in advance in the storage device 2023 of the mobile terminal 20a. Further, in the POS register 10c, the decryption unit 117 holds a public key and a private key corresponding to the public key in advance.

The description below is given, for example, assuming a case where the user 30 purchases a product by making a payment using a two-dimensional code. In the POS register 10c, the product information is input by the input device 101, and the input product information is delivered from the input unit 111 to the code generation unit 113a (step S100). The code generation unit 113a acquires the public key from the decryption unit 117, and generates a two-dimensional code (QR code in this example) based on the delivered product information and the public key (step S1010). The mobile terminal 20a causes the display unit 112 to display the two-dimensional code image 11 by the two-dimensional code generated by the code generation unit 113a on the display 100 (step S102).

The user 30 starts the terminal-side payment processing program according to the second embodiment on the mobile terminal 20a. The terminal-side payment processing program according to the second embodiment is obtained by adding the function of the encryption unit 240 to the terminal-side payment processing program according to the first embodiment described above.

Then, the user 30 captures the two-dimensional code image 11 displayed on the display 100 of the POS register 10 in the mobile terminal 20 in step S102 with the rear-side camera 201 of the user's mobile terminal 20 and reads out the two-dimensional code that is based on the two-dimensional code image 11 (step S200). The code readout unit 212 extracts and analyzes the two-dimensional code image 11 from the captured image that is delivered from the image-capturing unit 210 to acquire the two-dimensional code. Then, the code readout unit 212 obtains the product information and the public key from the extracted two-dimensional code.

The mobile terminal 20a causes the touch panel 220 (the display device 2031) to display transaction information that includes the product information of the product purchased by the user 30 based on the read-out two-dimensional code by the display unit 215 (step S201).

If the user 30 performs a user operation on the mobile terminal 20a (step S202) and the user operation instructs the payment to proceed, the mobile terminal 20a captures the face of the user 30 with the front-side camera 200 to recognize the user 30 on the basis of the face included in the captured image (step S203).

If the user 30 is recognized by the mobile terminal 20a in step S203, the ranging unit 211 of the mobile terminal 20a measures a distance D_{USER} between the mobile terminal 20a and the user 30 with the front-side ranging unit 202 in step S204. Furthermore, the ranging unit 211 of the mobile terminal 20 measures a distance D_{POS} between the mobile terminal 20 and the POS register 10c with the rear-side ranging unit 203 in step S205.

In the mobile terminal 20, in step S206, the determination unit 214 authenticates the user 30 and determines whether or not to execute the payment processing on the basis of the face recognized in step S203 and the distances D_{USER} and D_{POS} respectively obtained in steps S204 and S205.

In a case where the mobile terminal 20a determines to execute the current payment processing by the determination processing in step S206, the processing proceeds to step S2061. In step S2061, the encryption unit 240 encrypts the payment information including the transaction information using the public key extracted from the two-dimensional code by the code readout unit 212 in step S200. In the next step S207, the mobile terminal 20a transmits the encrypted payment information to the POS register 10c by the optical communication unit 217 using optical communication.

The encrypted payment information is transmitted to the POS register 10 via the space between the mobile terminal 20 and the POS register 10c by optical communication using light emitted from the rear-side ranging unit 203 (step S208), and received by the light reception unit 102 of the POS register 10c (step S103).

The POS register 10 demodulates, by the reception light processing unit 110, the light emitted from the mobile terminal 20 and received by the light reception unit 102, and restores the payment information. The restored payment information is encrypted using the public key in the mobile terminal 20a. In step S1031, the POS register 10c decrypts the encryption of the restored payment information by the decryption unit 117.

The POS register 10c transmits the restored and decrypted payment information to the payment server 40 via the network 2 by the communication unit 114 (step S104). The payment server 40 performs payment processing according to the payment information transmitted from the POS register 10c (step S400), and transmits a result of the payment processing including information on whether or not the payment has succeeded to the POS register 10 via the network 2 (step S401).

The POS register 10c receives the payment processing result transmitted from the payment server 40 by the communication unit 114, and generates a two-dimensional code indicating the received payment processing result by the code generation unit 113a (step S105). The two-dimensional code generated in step S105 does not include a public key. The code generation unit 113a delivers the generated two-dimensional code to the display unit 112. The POS register 10c generates the two-dimensional code image 11 used to display the two-dimensional code on the basis of the two-dimensional code delivered from the code generation unit 113a and causes the display unit 112 to display the generated two-dimensional code image 11 on the display 100 (step S106).

The mobile terminal 20a captures, according to the operation of the user 30, for example, the two-dimensional code image 11 displayed on the display 100 of the POS register 10c in step S105 with the rear-side camera 201 of own mobile terminal 20 and reads out the two-dimensional code that is based on the two-dimensional code image 11 (step S209). The mobile terminal 20a causes the touch panel 220 (the display device 2031) to display the result of payment based on the read-out two-dimensional code by the display unit 215 (step S210).

As described above, in the second embodiment, the two-dimensional code image 11 including the public key is displayed on the display 100 of the POS register 10c. The mobile terminal 20a encrypts the payment information using the public key included in the two-dimensional code image 11 read out from the display of the display 100 of the POS register 10c, and transmits the encrypted payment information to the POS register 10c using optical communication. Therefore, it is possible to more securely transmit the payment information by optical communication. In addition, since the public key is included in the two-dimensional code image 11 displayed on the display 100 of the POS register 10c, it is not necessary to use the Internet when the public key is delivered to the mobile terminal 20a.

Note that each modification of the first embodiment described above can be applied to the second embodiment alone or in combination within a range not contradictory to each other.

Moreover, the effects described in the present specification are merely illustrative and are not restrictive, and other effects are achievable.

Note that the present technology may include the following configuration.
(1) A terminal apparatus comprising:
   a first ranging unit including a light source unit and a light reception unit and configured to perform range-finding on a basis of light emitted from the light source unit and light received by the light reception unit; and
   a control unit configured to control the first ranging unit, wherein
   the control unit
   controls light emission from the light source unit included in the first ranging unit in response to transmission data to transmit the transmission data to another equipment using light and to cause the first ranging unit to execute the range-finding at least once before completing transmission of the transmission data.
(2) The terminal apparatus according to the above (1), wherein
   the control unit
   causes the transmission data to be transmitted in a case where a distance obtained by the range-finding is equal to or less than a threshold.
(3) The terminal apparatus according to the above (1) or (2), further comprising:
   a readout unit configured to read out a code that is based on image information, wherein
   the control unit
   causes the transmission data to be generated on a basis of the code read out by the readout unit.
(4) The terminal apparatus according to the above (3), wherein
   the readout unit has an image sensor that captures an image to acquire a captured image, and
   the control unit
   causes the transmission data to be generated on a basis of the captured image acquired by the readout unit.
(5) The terminal apparatus according to the above (3), wherein
   the light reception unit included in the first ranging unit has a plurality of light reception elements, each of which receives light, and
   the readout unit generates the transmission data on a basis of light received by the plurality of light reception elements of the light reception unit included in the first ranging unit.
(6) The terminal apparatus according to the above (5), wherein
   the control unit
   makes the number of the light reception elements driven upon executing the range-finding by the first ranging unit among the plurality of the light reception elements smaller than the number of the light reception elements driven upon generating the transmission data on the basis of light received by the light reception unit included in the first ranging unit.
(7) The terminal apparatus according to any one of the above (3) to (6), wherein
   the readout unit, the light source unit, and the light reception unit are arranged on a first surface of the terminal apparatus, the light source unit and the light reception unit being included in the first ranging unit, and
   the control unit
   causes the first ranging unit to execute the range-finding for measuring a distance to the another equipment.
(8) The terminal apparatus according to the above (7), wherein
   the control unit
   controls an intensity of the light emitted from the light source unit to be adjusted upon transmitting the transmission data to the another equipment depending on a result obtained by executing the range-finding for measuring the distance to the another equipment.
(9) The terminal apparatus according to the above (7) or (8), further comprising:
   a second ranging unit configured to perform range-finding on a second surface opposite to the first surface,
   wherein the control unit further causes the second ranging unit to execute the range-finding for measuring a distance to a user operating the terminal apparatus.
(10) The terminal apparatus according to the above (9), wherein
   the control unit
   causes the transmission data to be transmitted in a case where a first distance is equal to or less than a first threshold and a second distance is equal to or less than a second threshold, the first distance being obtained by the first ranging unit, the second distance being obtained by the second ranging unit.
(11) The terminal apparatus according to the above (10), wherein
   the first threshold is smaller than the second threshold.
(12) The terminal apparatus according to any one of the above (1) to (11), wherein
   the control unit
   makes an irradiation area where light is emitted by the light source unit different between a case where the first ranging unit performs the range-finding and a case where the transmission data is transmitted to the another equipment, the irradiation area in the case where the transmission data is transmitted to the another equipment being adjusted by controlling the light emission from the light source unit.
(13) The terminal apparatus according to any one of the above (1) to (12), further comprising:
   an image-capturing unit configured to perform image-capturing in a range including a direction in which the light source unit emits light for transmission of the transmission data to acquire a captured image, wherein
   the control unit
   specifies a position of a light reception unit for the another equipment to receive light emitted from the light source unit for transmission of the transmission data and directs a direction in which the light source unit emits light to the specified position upon transmitting the transmission data by the light source unit on a basis of the captured image acquired by the image-capturing unit.
(14) The terminal apparatus according to any one of the above (1) to (13), further comprising:
   an encryption unit configured to encrypt data, wherein
   the control unit
   causes the transmission data to be encrypted by the encryption unit and controls light emission by the light source unit depending on the encrypted transmission data to transmit the encrypted transmission data to the another equipment.
(15) The terminal apparatus according to the above (14), further comprising:
   a readout unit configured to read out a code that is based on image information, wherein
   the encryption unit
   acquires a public key included in the code read out by the readout unit to encrypt the transmission data using the acquired public key.
(16) An information processing apparatus comprising:
   a generation unit configured to generate a first code that is based on an image on a basis of input information to cause the first code to be displayed on a display unit; and
   a receiver configured to receive transmission data transmitted using light from another equipment, wherein
   the generation unit
   generates a second code that is based on an image on a basis of the transmission data received by the receiver and causes the generated second code to be displayed on the display unit.
(17) The information processing apparatus according to the above (16), further comprising:
   a decryption unit configured to decrypt data encrypted with a public key using a private key corresponding to the public key, wherein
   the generation unit
   generates the first code on a basis of the public key and the input information to cause the first code to be displayed on the display unit, and
   the decryption unit
   decrypts, with the private key, the transmission data transmitted using light from the another equipment.
(18) The information processing apparatus according to the above (16) or (17), further comprising:
   a communication unit configured to communicate with a sever via a network, wherein
   the generation unit
   transmits the transmission data received by the receiver to the server through the communication unit and generates the second code on a basis of data received from the server in response to the transmission of the transmission data.
(19) An information processing system comprising:
   a terminal apparatus; and an information processing apparatus, wherein
   the terminal apparatus includes
   a ranging unit including a light source unit and a light reception unit and configured to perform range-finding on a basis of light emitted from the light source unit and light received by the light reception unit,
   a readout unit configured to read out a code that is based on image information, and
   a control unit configured to control light emission by the light source unit included in the ranging unit in response to transmission data to transmit the transmission data using light to the information processing apparatus and to cause the ranging unit to execute the range-finding at least once before completing transmission of the transmission data, wherein
   the information processing apparatus includes
   a receiver configured to receive the transmission data transmitted using light from the terminal apparatus, and
   a generation unit configured to generate a first code that is based on an image on a basis of input information, causing the first code to be displayed on a display unit and configured to generate a second code that is based on an image on a basis of the transmission data received by the receiver, causing the second code to be displayed on the display unit, wherein
   the control unit
   causes the readout unit to read out the first code, causes the transmission data to be generated on a basis of information included in the read-out first code, and causes the generated transmission data to be transmitted using light to the information processing apparatus.
(20) An information processing method
   executed by a processor, the method comprising:
   a ranging step of performing range-finding on a basis of light emitted from a light source unit and light received by a light reception unit; and
   a control step of controlling the ranging step, wherein,
   in the control step,
   light emission by the light source unit is controlled in response to transmission data to transmit the transmission data to another equipment, causing the range-finding to be executed in the ranging step at least once before completing transmission of the transmission data.

### REFERENCE SIGNS LIST

1 INFORMATION PROCESSING SYSTEM
2 NETWORK
10, 10a, 10b, 10c POS REGISTER
11, 11a, 11b TWO-DIMENSIONAL CODE IMAGE
20, 20a MOBILE TERMINAL
30 USER
40 PAYMENT SERVER
60 TRANSACTION INFORMATION SCREEN
61 TRANSMISSION SCREEN
62a, 62b PAYMENT RESULT SCREEN
70 PRODUCT SHELF
80 CART
81 CART TERMINAL
100 DISPLAY
101 INPUT DEVICE
102 LIGHT RECEPTION UNIT
110 RECEPTION LIGHT PROCESSING UNIT
111, 216 INPUT UNIT
112, 215 DISPLAY UNIT
113, 113a CODE GENERATION UNIT
114 COMMUNICATION UNIT
115 PAYMENT PROCESSING UNIT
116, 219 CONTROL UNIT
117 DECRYPTION UNIT
200 FRONT-SIDE CAMERA
201 REAR-SIDE CAMERA
202 FRONT-SIDE RANGING UNIT
203 REAR-SIDE RANGING UNIT
210 IMAGE-CAPTURING UNIT
211 RANGING UNIT
212 CODE READOUT UNIT
213 FACIAL RECOGNITION UNIT
214 DETERMINATION UNIT
217 OPTICAL COMMUNICATION UNIT
218 STORAGE UNIT
240 ENCRYPTION UNIT
220 TOUCH PANEL
2030 INPUT DEVICE
2031 DISPLAY DEVICE

1. A terminal apparatus comprising:
a first ranging unit including a light source unit and a light reception unit and configured to perform range-finding on a basis of light emitted from the light source unit and light received by the light reception unit; and
a control unit configured to control the first ranging unit, wherein
the control unit
controls light emission from the light source unit included in the first ranging unit in response to transmission data to transmit the transmission data to another equipment using light and to cause the first ranging unit to execute the range-finding at least once before completing transmission of the transmission data.

2. The terminal apparatus according to claim 1, wherein
the control unit
causes the transmission data to be transmitted in a case where a distance obtained by the range-finding is equal to or less than a threshold.

3. The terminal apparatus according to claim 1, further comprising:
a readout unit configured to read out a code that is based on image information, wherein
the control unit
causes the transmission data to be generated on a basis of the code read out by the readout unit.

4. The terminal apparatus according to claim 3, wherein
the readout unit has an image sensor that captures an image to acquire a captured image, and
the control unit
causes the transmission data to be generated on a basis of the captured image acquired by the readout unit.

5. The terminal apparatus according to claim 3, wherein
the light reception unit included in the first ranging unit has a plurality of light reception elements, each of which receives light, and
the readout unit generates the transmission data on a basis of light received by the plurality of light reception elements of the light reception unit included in the first ranging unit.

6. The terminal apparatus according to claim 5, wherein
the control unit
makes the number of the light reception elements driven upon executing the range-finding by the first ranging unit among the plurality of the light reception elements smaller than the number of the light reception elements driven upon generating the transmission data on the basis of light received by the light reception unit included in the first ranging unit.

7. The terminal apparatus according to claim 3, wherein
the readout unit, the light source unit, and the light reception unit are arranged on a first surface of the terminal apparatus, the light source unit and the light reception unit being included in the first ranging unit, and
the control unit
causes the first ranging unit to execute the range-finding for measuring a distance to the another equipment.

8. The terminal apparatus according to claim 7, wherein
the control unit
controls an intensity of the light emitted from the light source unit to be adjusted upon transmitting the transmission data to the another equipment depending on a result obtained by executing the range-finding for measuring the distance to the another equipment.

9. The terminal apparatus according to claim 7, further comprising:
a second ranging unit configured to perform range-finding on a second surface opposite to the first surface,
wherein the control unit further causes the second ranging unit to execute the range-finding for measuring a distance to a user operating the terminal apparatus.

10. The terminal apparatus according to claim 9, wherein
the control unit
causes the transmission data to be transmitted in a case where a first distance is equal to or less than a first threshold and a second distance is equal to or less than a second threshold, the first distance being obtained by the first ranging unit, the second distance being obtained by the second ranging unit.

11. The terminal apparatus according to claim 10, wherein
the first threshold is smaller than the second threshold.

12. The terminal apparatus according to claim 1, wherein
the control unit
makes an irradiation area where light is emitted by the light source unit different between a case where the first ranging unit performs the range-finding and a case where the transmission data is transmitted to the another equipment, the irradiation area in the case where the transmission data is transmitted to the another equipment being adjusted by controlling the light emission from the light source unit.

13. The terminal apparatus according to claim 1, further comprising:
an image-capturing unit configured to perform image-capturing in a range including a direction in which the light source unit emits light for transmission of the transmission data to acquire a captured image, wherein
the control unit
specifies a position of a light reception unit for the another equipment to receive light emitted from the light source unit for transmission of the transmission data and directs a direction in which the light source unit emits light to the specified position upon transmitting the transmission data by the light source unit on a basis of the captured image acquired by the image-capturing unit.

14. The terminal apparatus according to claim 1, further comprising:
an encryption unit configured to encrypt data, wherein
the control unit
causes the transmission data to be encrypted by the encryption unit and controls light emission by the light source unit depending on the encrypted transmission data to transmit the encrypted transmission data to the another equipment.

15. The terminal apparatus according to claim 14, further comprising:
a readout unit configured to read out a code that is based on image information, wherein
the encryption unit
acquires a public key included in the code read out by the readout unit to encrypt the transmission data using the acquired public key.

16. An information processing apparatus comprising:
a generation unit configured to generate a first code that is based on an image on a basis of input information to cause the first code to be displayed on a display unit; and
a receiver configured to receive transmission data transmitted using light from another equipment, wherein
the generation unit
generates a second code that is based on an image on a basis of the transmission data received by the receiver and causes the generated second code to be displayed on the display unit.

17. The information processing apparatus according to claim 16, further comprising:
a decryption unit configured to decrypt data encrypted with a public key using a private key corresponding to the public key, wherein
the generation unit
generates the first code on a basis of the public key and the input information to cause the first code to be displayed on the display unit, and
the decryption unit
decrypts, with the private key, the transmission data transmitted using light from the another equipment.

18. The information processing apparatus according to claim 16, further comprising:
a communication unit configured to communicate with a sever via a network, wherein
the generation unit
transmits the transmission data received by the receiver to the server through the communication unit and generates the second code on a basis of data received from the server in response to the transmission of the transmission data.

19. An information processing system comprising:
a terminal apparatus; and an information processing apparatus, wherein
the terminal apparatus includes
a ranging unit including a light source unit and a light reception unit and configured to perform range-finding on a basis of light emitted from the light source unit and light received by the light reception unit,
a readout unit configured to read out a code that is based on image information, and
a control unit configured to control light emission by the light source unit included in the ranging unit in response to transmission data to transmit the transmission data using light to the information processing apparatus and to cause the ranging unit to execute the range-finding at least once before completing transmission of the transmission data, wherein
the information processing apparatus includes
a receiver configured to receive the transmission data transmitted using light from the terminal apparatus, and
a generation unit configured to generate a first code that is based on an image on a basis of input information, causing the first code to be displayed on a display unit and configured to generate a second code that is based on an image on a basis of the transmission data received by the receiver, causing the second code to be displayed on the display unit, wherein
the control unit
causes the readout unit to read out the first code, causes the transmission data to be generated on a basis of information included in the read-out first code, and causes the generated transmission data to be transmitted using light to the information processing apparatus.

20. An information processing method
executed by a processor, the method comprising:
a ranging step of performing range-finding on a basis of light emitted from a light source unit and light received by a light reception unit; and
a control step of controlling the ranging step, wherein,
in the control step,
light emission by the light source unit is controlled in response to transmission data to transmit the transmission data to another equipment, causing the range-finding to be executed in the ranging step at least once before completing transmission of the transmission data.
